(19) United States
(12) Patent Application Publication
(10) Pub. No.: US 2016/0178965 A1
(43) Pub. Date: Jun. 23, 2016

(54) DISPLAY DEVICE AND MANUFACTURING METHOD OF THE SAME

(71) Applicant: Kabushiki Kaisha Toshiba, Minato-ku (JP)

(72) Inventors: Satoshi TAKAYAMA, Kawasaki (JP); Taeko Urano, Arakawa (JP); Tsutomu Nakanishi, Yokohama (JP); Kenji Nakamura, Kawasaki (JP); Yuko Kizu, Yokohama (JP); Honam Kwon, Kawasaki (JP)

(73) Assignee: Kabushiki Kaisha Toshiba, Minato-ku (JP)

(21) Appl. No.: 15/057,313

(22) Filed: Mar. 1, 2016

Related U.S. Application Data
(63) Continuation of application No. PCT/JP2014/004627, filed on Sep. 9, 2014.

(30) Foreign Application Priority Data
Sep. 20, 2013 (JP) 2013-195040

(51) Int. Cl. G02F 1/1335; G02B 5/09; G02B 3/00

(52) U.S. Cl. CPC G02F 1/133553; G02B 3/0056; G02B 3/0075; G02B 5/09; G02F 1/133526

(57) ABSTRACT

A display device includes: a mirror part which includes a reflective film formed at one surface of a transparent flat plate, and a plurality of micro-windows formed at the reflective film; a flat display part which emits non-parallel light whose light emission angle distribution is skewed in a normal direction toward the mirror part; and a microlens array part which is disposed between the mirror part and the flat display part, and includes a plurality of microlenses converging the non-parallel light emitted from the flat display part to the plurality of micro-windows individually.

### CROSS-REFERENCE TO RELATED APPLICATIONS

This application is a continuation of prior International Application No. PCT/JP2014/004627 filed on Sep. 9, 2014, which is based upon and claims the benefit of priority from Japanese Patent Application No. 2013-195040 filed on Sep. 20, 2013; the entire contents of all of which are incorporated herein by reference.

### FIELD

Embodiments described herein relate generally to a display device and a manufacturing method of the same.

### BACKGROUND

A device in which a front surface side of a thin display such as a liquid crystal display is closed by a half mirror (a mirror display) has been put into practical use. The mirror display has a structure in which the thin display is provided in a casing or in a wall where outside light is shut out, and a display side is made darker than a provided space by closing a front surface side space of the display by the half mirror whose light reflectivity is approximately 50%. In the mirror display as stated above, the half mirror is normally made function as a mirror. When an image is displayed on a display screen, backlight of the display is transmitted to the front surface side via the half mirror, and thereby, the image is visually recognized from the front surface side of the half mirror.

In a conventional mirror display, the image is displayed by transmitting the backlight to the front surface side via the half mirror, and therefore, the half mirror whose reflectivity and transmittance of light are each approximately 50% is used. There is a defect in the mirror display that the screen is dark compared to a normal mirror. There is a tendency in which the screen totally seems yellowish affected by a thickness of a metal film which constitutes the half mirror or the like. If the function as the mirror is improved by increasing the reflectivity of light by the half mirror, an amount of light transmitting through the half mirror decreases, and the screen becomes dark when the image is displayed. Therefore, it has been required to increase an amount of transmitted light when the image is displayed while increasing the reflectivity of light to improve the function as the mirror.

In addition to the mirror display, a hybrid-type liquid crystal display in which reflection and transmission of light are used is known. In the hybrid-type liquid crystal display, a reflection display is performed by using light in which outside light is reflected when the outside light such as sunlight and illumination light are obtained at a periphery thereof, and a transmission display is performed by using light in which backlight is transmitted when the outside light is dark. According to this method, it is possible to suppress power consumption by turning off the backlight when the outside light is obtained, and therefore, it is often used for a liquid crystal display device for mobile use which is battery-driven. The half mirror is used as a means to transmit the backlight while reflecting the outside light also in the hybrid-type liquid crystal display.

The hybrid-type liquid crystal display using the half mirror has problems similar to the mirror display. Namely, the screen is easy to be dark, further hue deviation is easy to occur in case of the reflection display. When the light reflectivity by the half mirror is increased to increase luminance of the reflection display, the light intensity through the half mirror decreases, and therefore, the screen of the transmission display becomes dark. A hybrid-type liquid crystal display using a metal layer such as a pixel electrode as a partial mirror instead of the half mirror is also known. In the partial mirror, reflection light and transmission light are in a complete trade-off relationship, and therefore, it is impossible to improve both image qualities of the reflection display and the transmission display. Therefore, it has been required to improve the amount of transmitted light of the backlight to improve the image quality of the transmission display while improving the light reflectivity to improve the image quality of the reflection display.

### BRIEF DESCRIPTION OF THE DRAWINGS

FIG. 1 is a view illustrating a display device according to a first embodiment.

FIG. 2 is a view illustrating a constitution example of a backlight used for the display device illustrated in FIG. 1.

FIG. 3 is a view illustrating a light emission angle distribution of the backlight illustrated in FIG. 2.

FIG. 4 is a view illustrating a relationship between a shape of a first constitution example of a microlens array part used for the display device illustrated in FIG. 1 and an opening diameter of a micro-window.

FIG. 5 is a view illustrating a calculation example of a structure of the microlens array part illustrated in FIG. 4 and optical paths.

FIG. 6 is a view illustrating a modification example of FIG. 5.

FIG. 7 is a view illustrating another calculation example of the structure of the microlens array part illustrated in FIG. 4 and the optical paths.

FIG. 8 is a view illustrating a relationship between a shape of a second constitution example of the microlens array part used for the display device illustrated in FIG. 1 and the opening diameter of the micro-window.

FIG. 9A is a view illustrating a preparation process of a supporter in a manufacturing process example of a mirror part and the microlens array part of the display device illustrated in FIG. 1.

FIG. 9B is a view illustrating a formation process of the microlens array in the manufacturing process example of the mirror part and the microlens array part of the display device illustrated in FIG. 1.

FIG. 9C is a view illustrating a formation process of a reflective film in the manufacturing process example of the mirror part and the microlens array part of the display device illustrated in FIG. 1.

FIG. 9D is a view illustrating a formation process of a photosensitive layer in the manufacturing process example of the mirror part and the microlens array part of the display device illustrated in FIG. 1.

FIG. 9E is a view illustrating an exposure process of the photosensitive layer in the manufacturing process example of the mirror part and the microlens array part of the display device illustrated in FIG. 1.

FIG. 9F is a view illustrating a development process of the photosensitive layer in the manufacturing process example of the mirror part and the microlens array part of the display device illustrated in FIG. 1.

FIG. 9G is a view illustrating a formation process of the micro-windows in the manufacturing process example of the mirror part and the microlens array part of the display device illustrated in FIG. 1.

FIG. 9H is a view illustrating the formation process of the micro-windows in the manufacturing process example of the mirror part and the microlens array part of the display device illustrated in FIG. 1.

FIG. 9I is a view illustrating an adhesion process of a transparent flat plate in the manufacturing process example of the mirror part and the microlens array part of the display device illustrated in FIG. 1.

FIG. 10 is a view illustrating calculation results of transmission spectra at a region from a wavelength of 200 nm to 800 nm of an aluminum film.

FIG. 11 is a view illustrating calculation results of reflection spectra at the region from the wavelength of 200 nm to 800 nm of the aluminum film.

FIG. 12 is a view illustrating an example of absorption spectra at the region from the wavelength of 200 nm to 800 nm of the photosensitive layer.

FIG. 13 is a view illustrating an example of a relationship between an exposure time and a micropore size of the photosensitive layer.

FIG. 14 is a view illustrating an example of measurement results of the transmission and reflection spectra of the aluminum film.

FIG. 15 is a view illustrating a relationship between the exposure time and a micropore diameter of the reflection film when the photosensitive layer is exposed.

FIG. 16 is a view illustrating an example of a transmission spectrum measured from a microlens array part side of a composite body of the mircolens array part and the mirror part.

FIG. 17 is a view illustrating an example of a transmission spectrum measured from a mirror part side of the composite body of the microlens array part and the mirror part.

FIG. 18 is a view illustrating an example of a reflection spectrum measured from the mirror part side of the composite body of the microlens array part and the mirror part.

FIG. 19 is a sectional view illustrating a first modification example of the display device illustrated in FIG. 1.

FIG. 20 is a sectional view illustrating a second modification example of the display device illustrated in FIG. 1.

FIG. 21 is a sectional view illustrating a third modification example of the display device illustrated in FIG. 1.

FIG. 22 is a sectional view illustrating a fourth modification example of the display device illustrated in FIG. 1.

FIG. 23 is a sectional view illustrating a fifth modification example of the display device illustrated in FIG. 1.

FIG. 24 is a sectional view illustrating a sixth modification example of the display device illustrated in FIG. 1.

FIG. 25 is a sectional view illustrating a display device according to a second embodiment.

FIG. 26 is a sectional view enlarged illustrating a liquid crystal display part, a reflection part, and a microlens array part in the display device illustrated in FIG. 25.

FIG. 27 is a view illustrating a relationship between light reflectivity and light transmittance in the display device according to the second embodiment.

FIG. 28 is a sectional view illustrating a first modification example of the display device illustrated in FIG. 25.

FIG. 29 is a sectional view illustrating a second modification example of the display device illustrated in FIG. 25.

FIG. 30 is a sectional view enlarged illustrating a photosensor in a liquid crystal display of the display device illustrated in FIG. 29.

### DETAILED DESCRIPTION

A display device according to the embodiment includes: a mirror part which includes a flat plate transparent for visible light, a reflective film formed at one surface of the transparent flat plate, and a plurality of micro-windows formed at the reflective film; a flat display part which is disposed at a formation surface side of the reflective film of the mirror part, and emits non-parallel light whose light emission angle distribution is skewed in a normal direction toward the mirror part; and a microlens array part which is disposed between the mirror part and the flat display part, and includes a plurality of microlenses converging the non-parallel light emitted from the flat display part toward the mirror part to the plurality of micro-windows individually.

Hereinafter, display devices according to the embodiments are described with reference to the drawings. Note that there are cases when the same reference numerals and symbols are supplied to substantially the same component and a part of the description is not given in each embodiment. Please be noted that the drawings are schematic ones, and a relationship between a thickness and a flat dimension, a ratio of the thickness of each part, and so on are different from actual ones. Terms indicating directions such as upward and downward in the description indicate relative directions when a later-described display surface side of a flat display part is set to be upward unless other wise specified, and there is a case when it is different from a real direction in which a gravitational acceleration direction is set as a reference.

### First Embodiment

FIG. 1 is a sectional view illustrating a constitution of a display device according to a first embodiment. A display device 1 illustrated in FIG. 1 includes a flat display part 10, a microlens array part 20, and a mirror part 30. The display device 1 illustrated in FIG. 1 includes a backlight-type liquid crystal display as the flat display part 10. The flat display part 10 has a display surface 10a and a non-display surface 10b. A backlight which is not illustrated is disposed at the non-display surface 10b side of the liquid crystal display as the flat display part 10. The liquid crystal display has pixels 11A, 11B, 11C, 11D, and a color image is displayed by light which transmits through these pixels 11A to 11D.

Light emitted from the display surface 10a of the liquid crystal display is non-parallel light whose light emission angle distribution is skewed in a normal direction. The flat display part 10 is not limited to the backlight-type liquid crystal display, but may be a display which emits the non-parallel light whose light emission angle distribution is skewed in the normal direction. The flat display part 10 may be an organic EL display, a field-emission display, a plasma display, an LED display, and so on. It is preferable that the light emitted from the flat display part 10 is approximated to parallel light so as to effectively focus the light by later-described microlenses. A display in which an emission angle is optically focused is the normal direction is easy to be applied for the flat display part 10 by crossing, for example, trapezoidal linear prism sheets. When a surface light source which is nearer to parallel is required as the backlight of the flat display part 10, it is preferable to use triangle circular prism sheets, paraboloid sheets, and so on.

The mirror part 30 is disposed at the display surface 10a side of the flat display part 10. The mirror part 30 has a flat plate 31 which is transparent for visible light. A reflective film 32 is formed at one surface 31a of the transparent flat plate 31. A formation material of the transparent flat plate 31 may be either an inorganic material or an organic material. A glass plate and an acrylic resin plate with high transparency are suitably used for the transparent flat plate 31. A metal film whose reflectivity for the visible light is high or a dielectric multilayer film is used for the reflective film 32. The metal film as the reflective film 32 is preferable to be a thin film of silver, silver alloy, aluminum, aluminum alloy, and so on. The mirror part 30 is disposed such that the reflective film 32 is located at the display surface 10a side of the flat display part 10. A surface of the reflective film 32 is a mirror surface. The mirror part 30 functions as a mirror by reflecting light (outside light) OL which is incident on a surface (front face) 31b at an opposite side from the formation surface 31a of the reflective film 32 of the transparent flat plate 31.

The reflective film 32 has a plurality of micro-windows 33. The micro-windows 33 are ones formed by partially opening the reflective film 32. The micro-windows 33 function as transmission holes of the light emitted from the flat display part 10. A shape of the micro-window 33 is not particularly limited, and a square, a rectangle, a rhombus, a hexagon, an octagon, a circular, an oval, and so on are applicable. Note that there is a case when some errors occur in each hole shape form a designed shape when the micro-window 33 is manufactured by the later-described laser machining, but variation within a range satisfying a size condition is allowable. The micro-windows 33 are formed by, for example, performing a partial removal process by using high energy light such as laser light and the photoetching process using a mask for the metal film which is uniformly formed on the transparent flat plate 31 and a supporter 22 of the microlens array part 20. A formation method of the micro-windows 33 is not particularly limited, and the micro-windows 33 may be formed by applying the partial plating process, the vapor deposition process and the lift-off process after a masking layer is formed in accordance with a window pattern on the transparent flat plate 31 and the supporter 22 of the microlens array part 20. As the formation method of the micro-windows 33, reforming or the like by oxidation of the metal film (for example, the aluminum film) can be applied in addition to the removal of the metal film. The formation method of the micro-windows 33 is described later in detail.

It is preferable that the micro-window 33 has a size which cannot be recognized by a human visual sense when the mirror part 30 is functioned as a reflecting mirror when the flat display part 10 is not displayed. A resolution limit of the human visual sense can be cited as a standard. Namely, the size of the micro-window 33 is preferably set to be 1/16 mm (62.5 μm) or less being the resolution limit of the visual sense. The size of the micro-window 33 indicates a diameter in case of the circular, a major axis in case of the oval, and a length of a longest diagonal line in case of a polygon. The size of the micro-window 33 is preferable to be spreading of non-parallel light or more as it is described later. The size of the micro-window 33 is preferable to be smaller within a range of the size as stated above.

The microlens array part 20 having a plurality of microlenses 21 each of which converges the non-parallel light emitted from the flat display part 10 toward the mirror part 30 to the plurality of micro-windows 33 individually is disposed between the flat display part 10 and the mirror part 30. The plurality of microlenses 21 individually correspond to the micro-windows 33. Here, convex lenses are formed with a pitch of 100 μm as the microlenses 21. In each microlens 21, optical characteristics are adjusted such that the light incident from the flat display part 10 to a lens opening part is converged into the micro-window 33 and transmits. The pixels 11A to 11D of respective colors of the flat display part 10 correspond to individual microlenses 21 of the microlens array part 20.

FIG. 1 illustrates a constitution in which one microlens 21 and micro-window 33 are corresponded relative to one pixel 11 of the flat display part 10. A correspondence among the pixel 11, the microlens 21, and the micro-window 33 is not limited thereto. The plurality of microlenses 21 and micro-windows 33 may be corresponded for one pixel 11 of the flat display part 10. For example, when output light with few parallelism is used, a size of light capable of focusing becomes relatively large, and therefore, it is preferable to make the plurality of micro-windows 33 correspond for one pixel 11 because it is necessary to limit an area. On the other hand, one microlens 21 and micro-window 33 may be corresponded for a plurality of pixels 11A to 11D such as RGB. When the output light is the non-parallel light whose light emission angle distribution is skewed in the normal direction, it is suitable for a multi-pixel correspondence because it is easy to be converged by the microlens 21 and an area which corresponds to an opening diameter of the micro-window 33 can be made relatively large.

FIG. 1 illustrates the microlens array part 20 which has convex lenses as the microlenses 21. The microlens 21 is not limited thereto. A refractive lens such as a convex lens, a Fresnel lens, and a graded index (GRIN) lens, or a diffraction lens is used as the microlens 21. The microlens array part 20 is manufactured by a method in which a microlens array sheet which is manufactured in advance is adhered on the reflective film 32 while aligning positions, a method in which a microlens array having a plurality of microlenses 21 is directly formed by the printing method on the reflective film 32 of the mirror part 30, and so on. The microlens array part 20 may be formed simultaneously with the mirror part 30 by a series of processes without being limited to a case when it is manufactured as a separated body from the mirror part 30. The manufacturing processes of the microlens array part 20 and the mirror part 30 are described later in detail.

In the display device 1 illustrated in FIG. 1, the microlens array part 20 is disposed so as to be in close contact with each of the flat display part 10 and the mirror part 30. FIG. 1 illustrates a state in which the transparent flat sheet 31 having the reflective film 32 where the plurality of micro-windows 33 are formed and a microlens array sheet where the plurality of microlenses 21 are formed on the transparent supporter 22 such as a transparent sheet are prepared, and they are laminated to thereby bring the microlens array part 20 and the mirror part 30 in close contact. The reflective film 32 may be formed on a surface opposite to a formation surface of the microlenses 21 of the transparent supporter 22. In this case, the mirror part 30 is formed by adhesion the transparent flat plate 31 on the reflective film 32. The flat display part 10 may be proximity disposed with a space in which the microlens array part 20 is not completely in contact with the flat display part 10.

The display device 1 of the first embodiment functions as a mirror owing to the reflective film 32 reflecting the outside light OL when the flat display part 10 is in a non-display state. The plurality of micro-windows 33 are formed at the reflective film 32, but the micro-windows 33 are not visually recognized in a mirror image based on the size thereof. Namely, there is a characteristic in the human visual sense in which it becomes difficult to distinguish a color difference as an image area becomes small, a characteristic so-called as an area effect. On the other hand, there is a limit of a spatial resolution in the visual sense, and it is said normally to be 0.06 degrees, or approximately 1/16 mm (62.5 μm) at a most easily viewable focal length as a limit value. The micro-window 33 which is independently formed in a mirror (reflective film 32) with a size of the limit value of the spatial resolution or less cannot be visually recognized by reflection with human eyes resulting from physiological characteristics of visual sense as stated above. Accordingly, the reflective film 32 where the micro-windows 33 are formed functions as a mirror having the reflectivity defined by an open area ratio.

For example, when one side of each of the pixels 11A to 11D of the flat display part 10 is 200 μm, and a square micro-window 33 with one side of 20 μm is formed while making one micro-window 33 correspond to one pixel 11, the open area ratio of the micro-window 33 relative to the reflective film 32 is just 1% The reflective film 32 having the micro-windows 33 as stated above substantially has the optical characteristics equivalent to a normal mirror. The reflectivity of light by the reflective film 32 having the micro-windows 33 can be increased without deteriorating the function of the mirror resulting from the micro-windows 33 fallen upon the mirror image or the like. Therefore, it becomes possible to improve the function of the display device 1 as the mirror.

On the other hand, when the flat display part 10 is in a display state, light EL1 emitted from the flat display part 10 toward the mirror part 30 transmits through the micro-windows 33 because the light is converged to the micro-windows 33 by the microlenses 21. Light EL2 transmitting through the micro-windows 33 is emitted toward outside, and thereby, it is possible to visually recognize an image displayed by the flat display part 10 from a front surface (a surface 31b of the transparent flat plate 31) side of the mirror part 30. An optical component in which the micro-window and the microlens which focuses thereon are combined is optically asymmetry, and transmittance and reflectivity relative to parallel light are largely different depending on an incident angle. The optical component in which the micro-window and the microlens are combined based on the optical asymmetry as stated above is effective as a component which changes the light transmitting through the micro-windows into light near the parallel light or as a component which focuses the parallel light into one point.

Note that the flat display part 10 is generally a spread light source, and it is difficult to converge the non-parallel light emitted from the flat display part 10 to the micro-windows 33 by the microlenses 21. It is effective for the point as stated above to limit a range of an emission angle distribution of light emitted from the flat display part 10. It is effective to skew the light emission angle distribution (envelope) of the non-parallel light emitted from the display surface 10a of the flat display part 10 in the normal direction. The non-parallel light whose light emission angle distribution is skewed in the normal direction is easy to be converged to the micro-windows 33 by the microlenses 21. It is possible to increase an amount light transmitting through the mirror part 30 as for the light emitted from the flat display part 10 toward the mirror part 30. Therefore, it is possible to improve the display function of image at the front surface side of the mirror part 30 of the display device 1.

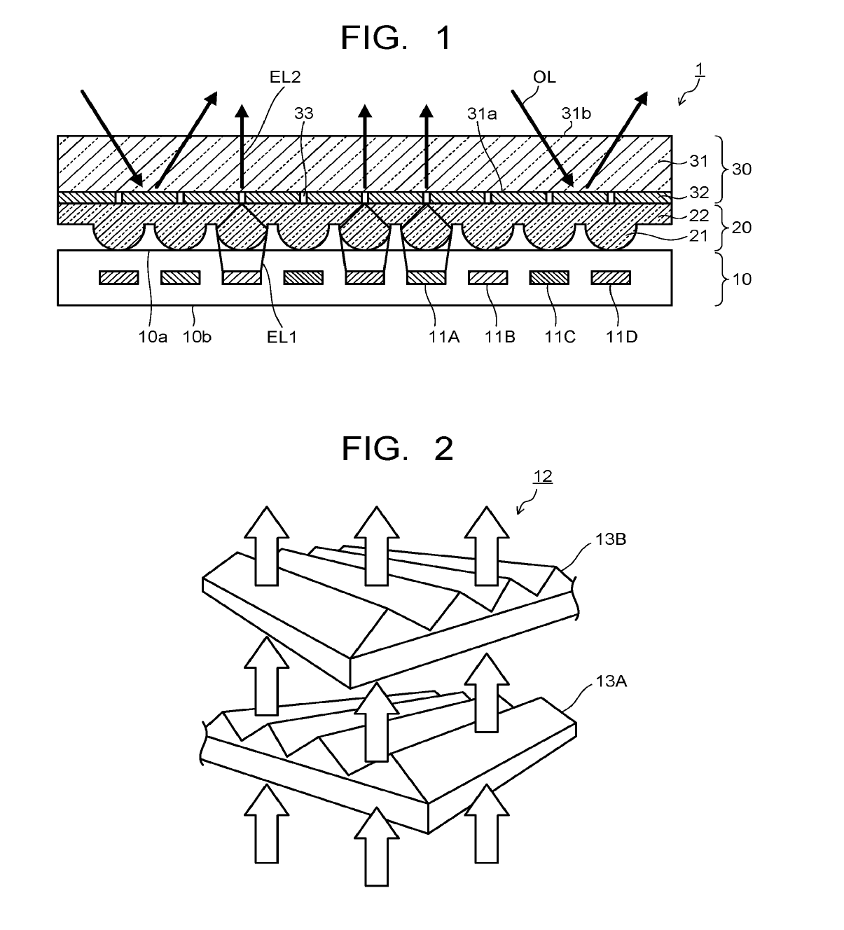

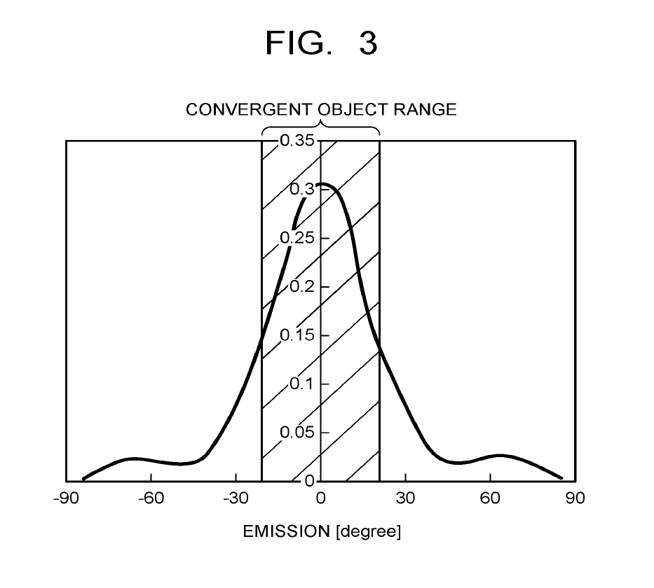

FIG. 2 illustrates an example of a backlight 12 which emits the non-parallel light whose light emission angle distribution is skewed in the normal direction. The backlight 12 illustrated in FIG. 2 has a structure in which two pieces of prism sheets (for example, BEF sheets manufactured by Sumitomo 3M corporation) 13A, 13B are orthogonally disposed on a not-illustrated spread light source. FIG. 3 illustrates the light emission angle distribution of the backlight 12 illustrated in FIG. 2. A maximum intensity of light emitted from the backlight 12 exists in the normal direction, and a range of ±45 degrees relative to the normal direction can be approximated by a Gaussian distribution. As a standard of a light converging range, light within a range from ½ (half value) of the maximum intensity to the maximum intensity (approximately ±20 degrees relative to the normal direction in FIG. 3) is selected, and it is preferable that a major part thereof passes through the micro-windows 33 formed at the reflective film 32.

It is necessary to skew the light emission angle distribution (envelope) in the normal direction from requirements on an optical design. As a practical standard, a half value width of the light emission angle distribution relative to air is preferably within ±25 degrees. Namely, when the backlight-type liquid crystal display is used as the flat display part 10, the light (non-parallel light) emitted from the backlight 12 preferably has the light emission angle distribution in which an angle forming the maximum intensity is the normal direction, and an angle to be ½ of the maximum intensity (angle at half maximum) A is within ±25 degrees relative to the normal direction. The non-parallel light having the light emission angle distribution as stated above is applied, and thereby, a major part thereof passes through the micro-windows 33. Therefore, it becomes possible to increase the amount of light transmitting through the mirror part 30. The angle θ to be ½ of the maximum intensity is more preferably within ±20 degrees relative to the normal direction.

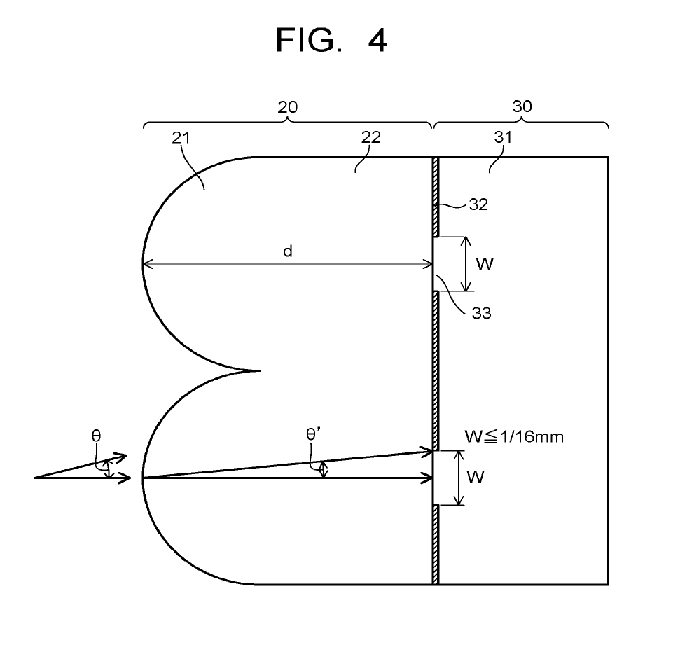

FIG. 4 illustrates a relationship between a shape of a first constitution example of the microlens array part 20 and an opening diameter W of the micro-window 33. The microlens array part 20 illustrated in FIG. 4 has the microlenses 21 each made up of a transparent material (refractive index n) relative to visible light and the supporter 22 made up of the same transparent material (refractive index n) as the formation material of the microlenses 21. A thickness (lens thickness) d of the microlens array part 20 is a total thickness of the microlens 21 and the supporter 22. When an air layer does not exist between the flat display part 10 and the microlens array part 20, spreading of light becomes the smallest. The light having the half value angle (converging angle) A also spreads at a converging angle θ′ (=arcsin(sin θ/n)) in a lens material. Also at a window surface, when the air layer does not exist between the supporter 22 of the microlens 21 and the reflective film 32, the spreading of light becomes the smallest, and the spreading of light having the half value angle θ becomes d·tan θ′.

The opening diameter W of the micro-window 33 preferably has a size of the spreading of light or more. Accordingly, it is preferable that the opening diameter W of the micro-window 33 satisfies the following relationship relative to the lens thickness d, the refractive index n of the transparent material, and the half value angle θ,

d·tan [arcsin(sin θ/n)]≦W/2.

Further, it is necessary to consider the above-stated physiological invisible condition (W 1/16 mm). It is preferable to select a smaller value as an upper limit value of the opening diameter W of the micro-window 33 by comparing the above-stated two values. The air layer existing between each component causes the spreading of light. It is preferable that the air layer does not exist between the flat display part 10 and the microlens array part 20, and between the microlens array part 20 and the mirror part 30. It is preferable that the flat display part 10, the microlens array part 20, and the mirror part 30 are each in close contact.

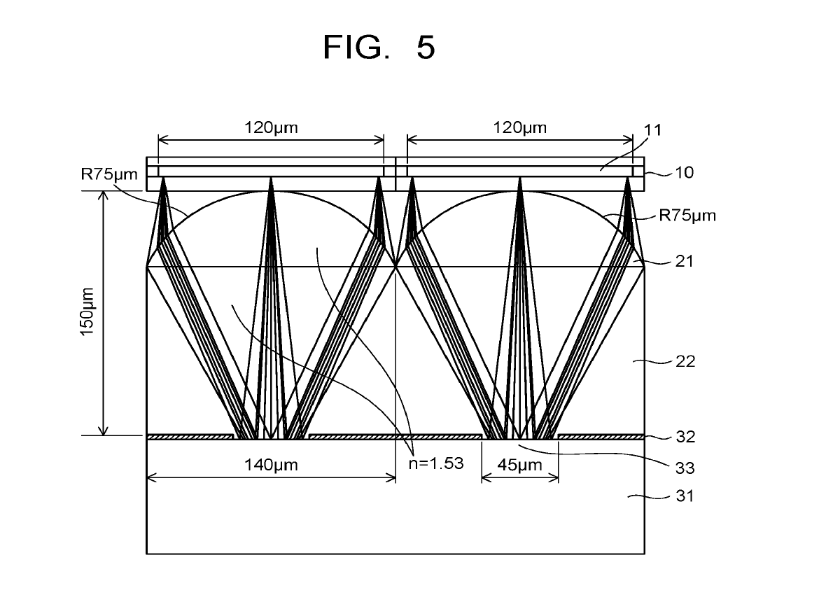

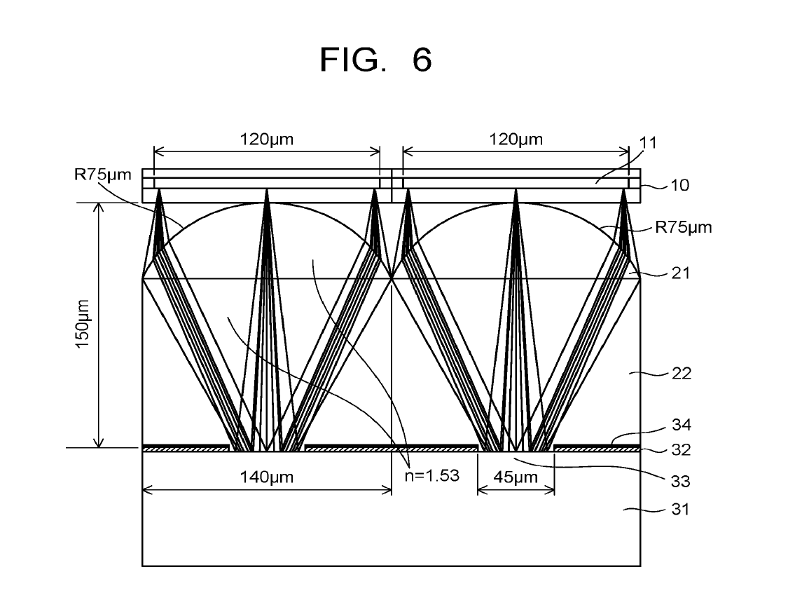

FIG. 5 illustrates a structure of the microlens 21 which is designed such that it is possible to converge light within a range of ±18 degrees and a calculation example of optical paths. A size of the pixel 11 is set to be 120 μm, and a formation pitch is set to be 140 μm. A lens radius of the microlens 21 which is formed in close contact with the pixel 11 is set to be 75 μm, a refractive index of the lens material is set to be 1.53, and the lens thickness d including the thickness of the supporter 22 is set to be 150 μm. In this case, the opening diameter W of the micro-window 33 is set to be 45 μm, then it is possible to let the light within a selected range pass through. FIG. 6 illustrates a modification example of FIG. 5. In a structure illustrated in FIG. 6, a rear surface (a surface opposite to a refraction surface of outside light) of the reflective film 32 is blackened. Light other than objects is absorbed by a blackened surface 34 as stated above, and thereby, it is possible to prevent turbulence of image caused by multiple reflection.

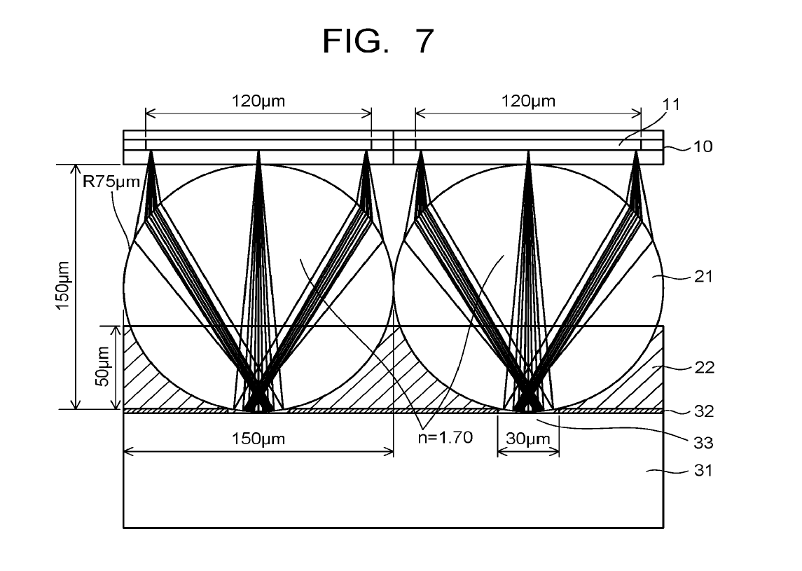

FIG. 7 illustrates a structure of the microlens 21 which is designed such that it is possible to converge light within a range of ±18 degrees different from FIG. 5 and a calculation example of optical paths. The size of the pixel 11 is set to be 120 μm, and the formation pitch is set to be 150 μm. The microlens 21 which is formed in close contact with the pixel 11 is a ball lens in a spherical state made up of a high refractive index glass whose refractive index is 1.70, and a diameter of the ball is set to be 150 μm. The thickness of the supporter 22 is 50 μm, but major light is not incident on the supporter 22 according to this structure, and therefore, it is possible to approximate the relationship between the lens thickness d and the opening diameter W by a single material. The high refractive index material is used for the microlens 21, and thereby, it is possible to make the opening diameter W of the micro-window 33 smaller than the structure illustrated in FIG. 5, and to let the light within the selected range at approximately 30 μm pass through.

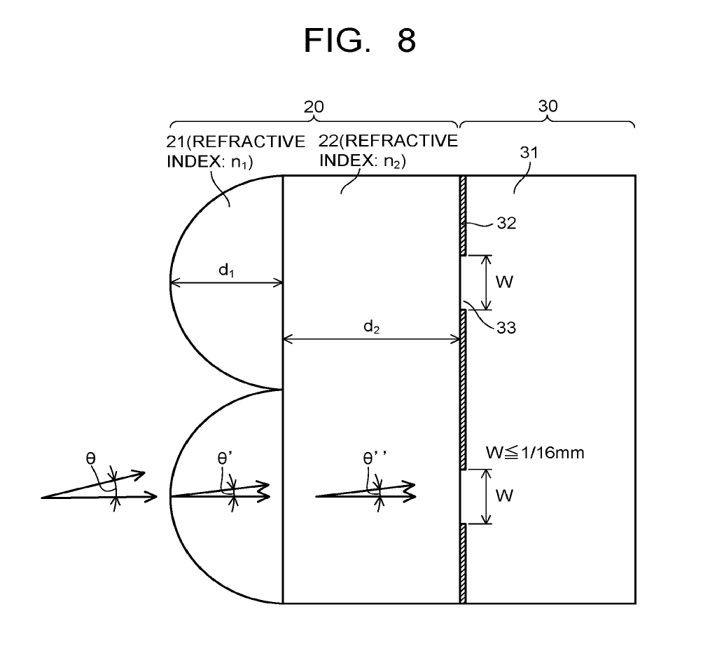

FIG. 8 illustrates a relationship between a shape of a second constitution example of the microlens array part 20 and the opening diameter W of the micro-window 33. The microlens array part 20 illustrated in FIG. 8 has the microlenses 21 each of which is made up of a first material (refractive index n1) which is transparent for visible light with a thickness of d1, and the supporter 22 which is made up of a second material (refractive index n2) transparent relative to visible light being different from the first material with a thickness of d2. According to this structure, the spreading of light becomes the smallest when the air layer does not exist between each of components. Similar to the first constitution example illustrated in FIG. 4, the opening diameter W of the micro-window 33 preferably has the size of the spreading of light or more.

It is preferable that the opening diameter W of the micro-window 33 satisfies the following relationship relative to the thickness d1 of the microlens 21, the thickness d2 of the supporter 22, the refractive index n1 of the first transparent material, the refractive index n2 of the second transparent material, and the half value angle θ,

d1·tan [arcsin(sin θ/n1)]+d2·tan [arcsin(sin θ/n2)]≦W/2.

Further, it is necessary to consider the above-stated physiological invisible condition (W≦ 1/16 mm). It is preferable to select a smaller value as an upper limit value of the opening diameter W of the micro-window 33 by comparing the above-stated two values.

The display device 1 according to the first embodiment is, for example, manufactured as described below. Here, a manufacturing process of the display device 1 illustrated in FIG. 1 is described in detail. At first, the microlens array part 20 is disposed at the formation surface side of the reflective film 32 of the mirror part 30. The microlens array part 20 is disposed such that the plurality of microlenses 21 respectively correspond to the micro-windows 33. The microlens array part 20 is preferably disposed to be in close contact with the reflective film 32 of the mirror part 30. Next, the flat display part 10 is disposed along the microlens array part 20. The flat display part 10 is disposed such that emitted light (non-parallel light) is converged to each of the plurality of micro-windows 33 via the plurality of microlenses 21. The flat display part 10 is preferably disposed to be in close contact with the microlens array part 20.

As stated above, the microlens array part 20 may be manufactured as a separated body from the mirror part 30, or may be simultaneously formed with the mirror part 30 by a series of processes. In either case, it is important to accurately align positions of the plurality of micro-windows 33 relative to the plurality of microlenses 21 respectively. When the microlens array part 20 is manufactured as the separated body from the mirror part 30, the plurality of micro-windows 33 are formed by a microfabrication technology represented by, for example, the optical lithography, and the plurality of microlenses 21 are formed by the printing method, the nanoimprint, and so on. When the micro-windows 33 and the microlenses 21 are manufactured by the separated processes, it is necessary to align a position of a center part of the microlens 21 to the micro-window (micropore part) 33 with high accuracy.

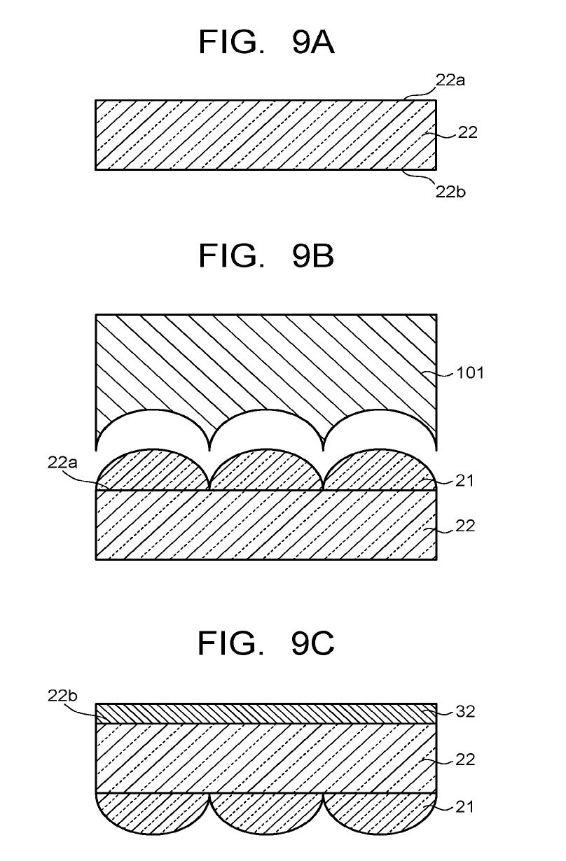

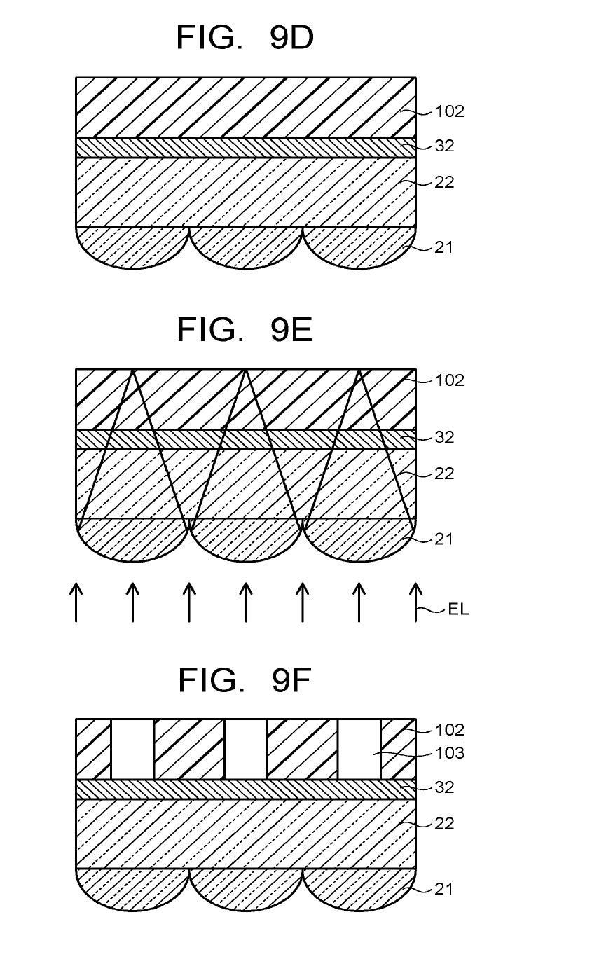

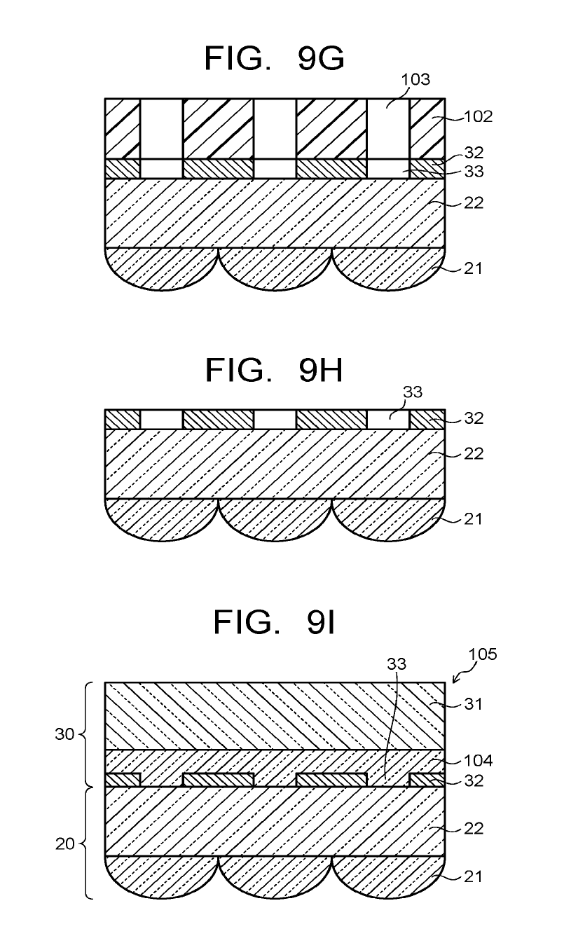

It is preferable to form the mirror part 30 simultaneously with the microlens array part 20 by a series of processes to reduce a manufacturing cost of a composite body of the microlens array part 20 and the mirror part 30 and to improve the positioning accuracy of the microlenses 21 and the micro-windows 33. The manufacturing process of the composite body of the microlens array part 20 and the mirror part 30 is described with reference to FIG. 9A to FIG. 9I. FIG. 9A to FIG. 9I illustrate the manufacturing process of the composite body of the microlens array part 20 and the mirror part 30 in which the reflective film 32 having the plurality of micro-windows 33 and the plurality of microlenses 21 are simultaneously formed by a series of processes.

As illustrated in FIG. 9A, the supporter 22 of the microlens array part 20 is prepared. A material of the supporter 22 may be either an inorganic material or an organic material, or may be a material where the inorganic material and the organic material are mixed. A transparent substrate such as, for example, a glass substrate and a resin substrate is used for the supporter 22. A size of the supporter 22 is not particularly limited. A thickness of the supporter 22 is preferable to be 10% or more and 200% or less of a focal length of the microlens 21 formed at a first surface 22a of the supporter 22. An appropriate surface treatment may be performed for the supporter 22 in consideration of adhesiveness of the supporter 22 with the microlens 21 and the reflective film 32.

It is preferable that light transmittance of the supporter 22 relative to a wavelength of 550 nm is 70% or more to increase use efficiency of light. Further, it is preferable that the supporter 22 has a wavelength region whose light transmittance is 10% or more relative to a later-described photosensitive wavelength region (for example, 450 nm or less) of a photosensitive layer. The material and the thickness of the supporter 22 are not particularly limited as long as the optical characteristics as stated above are held. The thickness of the supporter 22 is measured by using a micrometer. The focal length of the microlens 21 is found from a stage variation amount between a stage position when a focus is adjusted on a lens formation surface and a stage position when a focus is adjusted on a position where parallel light which is incident from a lens surface focuses at a lens center while, for example, monochromatic parallel light is incident from a lens surface side of the microlens 21 and the light is observed with an optical microscope. The optical characteristics of the supporter 22 is found by measuring transmission spectrum at an ultraviolet visible region by using, for example, an ultraviolet visible spectrophotometer.

As illustrated in FIG. 9B, the plurality of microlenses (microlens array) 21 are formed at the first surface 22a of the supporter 22. A formation method of the microlens array 21 is not particularly limited, and a widely general method can be applied. It is preferable to apply the nanoimprint method capable of forming a microlens structure with good controllability at a large area for a formation process of the microlens array 21. FIG. 9B illustrates a process forming the microlens array 21 by the nanoimprint using a transparent original plate 101. A material of the microlens array 21 may be any one of the organic material, the inorganic material, and the mixed material of inorganic and organic. As for the optical characteristics of the microlens array 21, it is preferable that the light transmittance relative to the wavelength of 550 nm is 70% or more and the wavelength region whose light transmittance is 10% or more is held at the photosensitive wavelength region (for example, 450 nm or less) of the photosensitive layer as same as the supporter 22.

A refractive index of the microlens array 21 is preferably 80% or more and less than 120% of the refractive index of the supporter 22. When the refractive index of the microlens array 21 is less than 80% of the refractive index of the supporter 22, the Fresnel reflection occurred at an interface with the supporter 22 becomes large, and the light use efficiency is lowered. When the refractive index of the microlens array 21 is 120% or more of the refractive index of the supporter 22, a total reflection occurs at the interface with the supporter 22, and the light use efficiency is lowered. The refractive index of the microlens array 21 is found by forming a flat film of the used material, and performing a spectrum analysis of the flat film by using an ellipsometer, a spectrophotometer, and so on.

A lens structure of the microlens array 21 may be any one of a circular, an oval, a triangle, a square, a hexagon when it is observed from a vertical direction of the array, and it is not particularly limited. A lens size of the microlens array 21 is preferably 1 μm or more and less than 500 μm. The lens size described here indicates a size of individual lens when the microlens array 21 is observed from the normal direction. It indicates a diameter of the circle in case of the circular, and indicates a length of a major axis in case of the oval. It indicates a diameter of a circle which inscribes a polygon in case of the polygon. When the lens size is less than intervals between the micro-windows 33 formed at the reflective film 32 become short, and therefore, a diffraction pattern of visible light becomes obvious, and a mirror performance of the reflective film 32 is lowered. When the lens size is 500 μm or more, each of the micro-windows 33 formed at the reflective film 32 approximates to a size capable of visually recognized, and the mirror performance of the reflective film 32 is lowered.

A lens curvature radius of the microlens array 21 is not particularly limited. The microlens array 21 may be arranged cyclically or in random. The random arrangement described here includes an arrangement without any order between adjacent lenses, and an arrangement in which domain regions in each of which a plurality of lenses are cyclically arranged are adjacent without any order. An area ratio occupied by the microlenses in a unit region (lens occupancy ratio) when the microlens array 21 is observed from the normal direction is preferable to be larger to converge light with high efficiency, and specifically, it is preferable to be 50% or more. A non-lens region is a flat surface, and therefore, the light incident on the non-lens region is not converged, and cannot transmit through the micro-windows 33. Therefore, optical loss becomes large when the lens occupancy ratio is less than 50%.

It is preferable that the microlens array 21 is arranged in a lenslet structure in which polygon-type lenses where the non-lens region is not generated are arranged with no space. The lens occupancy ratio thereby becomes 100%, and it is possible to converge light with high efficiency. The following methods can be cited as a measurement method of the lens occupancy ratio. The microlens array 21 is divided into a plurality of regions, and observation is performed for each region by using, for example, an optical microscope at a region where approximately 50 pieces of lenses are contained. Obtained observation images are processed by image processing software, and the lens occupancy ratio per a unit area is found. This process is performed at each region, and the lens occupancy ratio is found by obtaining an average value of each region.

As illustrated in FIG. 9C, the reflective film 32 is formed at a second surface 22b which is an opposite face of the first surface 22a of the supporter 22 where the microlens array 21 is formed. It is preferable that the light reflectivity relative to the wavelength of 550 nm is 70% or more and the wavelength region whose light transmittance is 0.1% or more is held at the photosensitive wavelength region (for example, 450 nm or less) of the photosensitive layer as for the optical characteristics of the reflective film 32. When the light reflectivity of the reflective film 32 relative to the wavelength of 550 nm is less than 70%, a mirror image becomes dark, and the mirror performance is lowered. When the reflective film 32 does not have the wavelength region whose light transmittance is 0.1% or more at the range of the wavelength of 450 nm or less, the photosensitive layer formed on the reflective film 32 is not able to be finely exposed to the light irradiated from the microlens array 21 side.

It is preferable to use aluminum, silver, or an alloy which contains at least one of them each having a high reflectivity at all regions of visible light, and whose plasma frequency exists at the ultraviolet light region as the material of the reflective film 32. The plasma frequency of aluminum exists in a vicinity of 120 nm, and the plasma frequency of silver exists in a vicinity of 320 nm. Aluminum and silver represent metallic optical characteristics at the visible light region, then represent dielectric optical characteristics as it goes to the ultraviolet light region. Therefore, aluminum and silver represent high reflectivity at the visible light region, and generate a transmitting property at the ultraviolet light region.

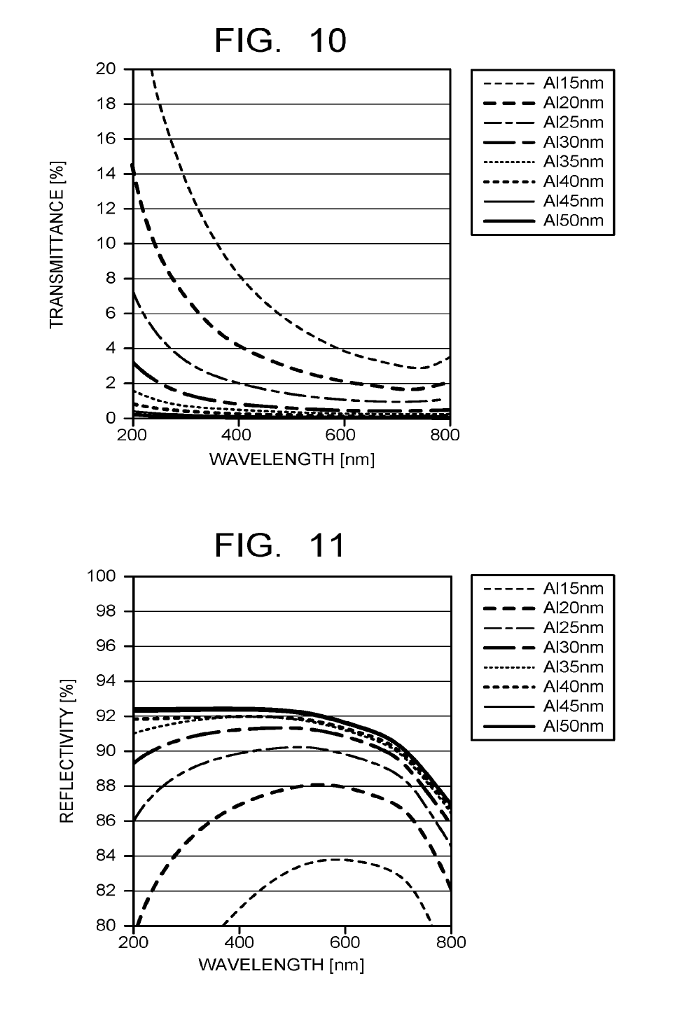

Calculation results of transmission spectrum and reflection spectrum at a region from a wavelength of 200 nm to 800 nm when an aluminum film is formed on a glass substrate are illustrated in FIG. 10 and FIG. 11. Here, the calculation is performed from a film thickness of 15 nm to 50 nm by every 5 nm. It turns out that high reflectivity is obtained at the visible light region, and the transmittance improves as it goes to the ultraviolet light region. Further, it turns out that the transmittance at the ultraviolet light region decreases as the film thickness becomes thick. The film thickness of the reflective film 32 is controlled with correspond to each material, and thereby, it is possible to control a visible light reflecting property and the ultraviolet light transmitting property. The material of the reflective film 32 is not limited to the metal material. A material capable of designing a spectrum shape such as a dielectric multilayer film may be used for the reflective film 32. A formation method of the reflective film 32 is not particularly limited, but it is preferable to use the vacuum deposition method, the sputtering method, the plating method, and so on capable of forming the reflective film 32 with high flatness.

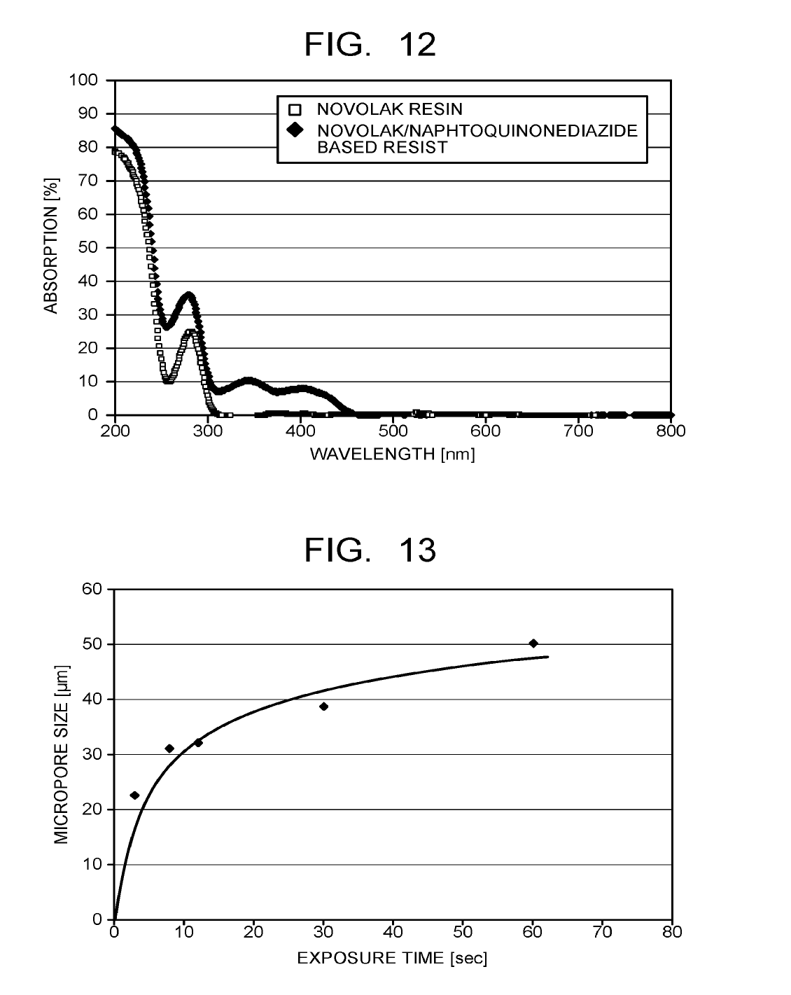

As illustrated in FIG. 9D, a photosensitive layer 102 is formed on the reflective film 32. An appropriate surface treatment may be performed for the reflective film 32 before the photosensitive layer 102 is formed to obtain adhesiveness of the photosensitive layer 102. For example, a positive-type photosensitive material whose photosensitive wavelength region exists at 450 nm or less is used as the material of the photosensitive layer 102. As the material as stated above, a resist material which is used for a general microfabrication is suitably used, and for example, a novolak/naphtoquinonediazide based resist is used. An absorption spectrum of a novolak resist where a novolak resin being a base resin and naphtoquinonediazide being a photosensitive agent are added at a region from a wavelength of 200 nm to 800 nm is illustrated in FIG. 12. Absorption is generated at a region from a wavelength of 300 nm to 450 nm in the novolak resist containing the photosensitive agent compared to an absorption spectrum of only the novolak resin being the base resin. The photosensitive wavelength region of the photosensitive layer 102 is able to be measured by a method as stated above.

As illustrated in FIG. 9E, light EL which has an light emitting region at a wavelength of 450 nm or less is irradiated for the photosensitive layer 102 from a formation surface side of the microlens array 21. The irradiated light EL is converged by the microlens array 21, transmits through the reflective film 32 having the ultraviolet light transmitting property, and the photosensitive layer 102 is exposed to light. As illustrated in FIG. 9F, when the photosensitive layer 102 is developed, a micropore pattern 103 is formed at the photosensitive layer 102. The irradiated light EL may be either parallel light or directivity distribution light which is skewed in the normal direction. A directivity half value width of the light EL is preferably 30 degrees or less. The directivity distribution is measured by evaluating an angle dependence of light intensity emitted from a light source within a range from −90 degrees to +90 degrees, and in general, it is approximated by a distribution curve in a gauss-type having a peak top in the normal direction (“0” (zero) degree). The directivity half value width indicates an angle in which the light intensity is lowered to ½ relative to peak light intensity in a vicinity of “0” (zero) degree at a region from “0” (zero) degree to 90 degrees of the directivity distribution. When the directivity half value width exceeds 30 degrees, the photosensitive layer 102 is totally easy to be exposed to light, and it becomes difficult to form the micropore pattern 103 with good controllability.

A relationship between an exposure time and a micropore size is illustrated in FIG. 13 when the novolak resist formed on the glass substrate is exposed to light by using a mercury lamp whose directivity half value width is approximately one degree. The micropore size increases in accordance with increase in the exposure time. It is possible to control the micropore size by the exposure time. It is preferable to determine the micropore size with high transmission characteristics in accordance with the directivity distribution of the liquid crystal display used as the flat display part 10. A positional relationship between the micropore pattern and the microlens array is verified by photographing an image while adjusting a focal plane of the optical microscope with each position of the micropore pattern and the microlens array, and overlapping each image. It is possible to form the micropore pattern at a lens center part by applying the method according to the embodiment. This is verified by the method as stated above.

As illustrated in FIG. 9G, the micro-windows 33 are formed at the reflective film 32 being a base while using the photosensitive layer 102 having the micropore pattern 103 as a mask. The patterning method of the reflective film 32 is not particularly limited, and it is possible to use the publicly known methods such as the wet-etching method, the dry-etching method, and the ion-milling method. It is preferable to apply the wet-etching method capable of reducing a formation cost of the micro-windows 33. As illustrated in FIG. 9H, the photosensitive layer 102 is removed. The photosensitive layer 102 may be remained depending on cases. As illustrated in FIG. 9I, the transparent flat plate 31 is adhered on the reflective film 32 with a transparent adhesive layer 104 therebetween. A composite body 105 of the microlens array part 20 and the mirror part 30 is thereby manufactured by a series of processes.

In the manufacturing process of the composite body 105, the micropore pattern 103 is formed at the photosensitive layer 102 by using the light-converging effect of the microlens array 21 formed on the supporter 22. Further, it is also possible to form the reflective film 32 having a micropore pattern 5 by forming the photosensitive layer 102 before the reflective film 32 is formed, forming the micropore pattern 103 at the photosensitive layer 102, precipitating an activation nuclear to perform the electroless plating for the photosensitive layer 102, and performing the electroless plating. It is also possible to form the reflective film 32 having the micro-windows 33 by forming a negative-type photosensitive material as the photosensitive layer 102 before the reflective film 32 is formed, remaining the region of the photosensitive layer 102 exposed to light, and forming the reflective film 32 by the lift-off method. It is also possible to form the reflective film 32 having the micro-windows 33 by forming a seed layer by electrolytic plating instead of the reflective film 32, forming the photosensitive layer 102, forming the micropore pattern 103 at the photosensitive layer 102, forming the micropore pattern at the seed layer, and performing the electrolytic plating by using the seed layer where the micropore pattern is formed after the photosensitive layer 102 is removed.

A concrete example of the manufacturing process of the composite body 105 is described below. A borosilicate glass substrate having a thickness of 150 μm was prepared as the supporter 22. The microlens array 21 was formed on the glass substrate by the optical imprinting method. A structure in which lenslet-type microlenses having a cycle of 50 μm, a zag depth of 12 μm, a curvature radius of 64 μm, and a lens occupancy ratio of 100% were disposed in closest packing was applied for the microlens array. A mold to form the microlens array was manufactured, an ultraviolet-curing resin was coated on the glass substrate, and the ultraviolet-curing resin was cured by irradiating ultraviolet light under a state in which the mold was imprinted by an optical imprinting device. The microlens array was formed on the glass substrate by releasing the mold.

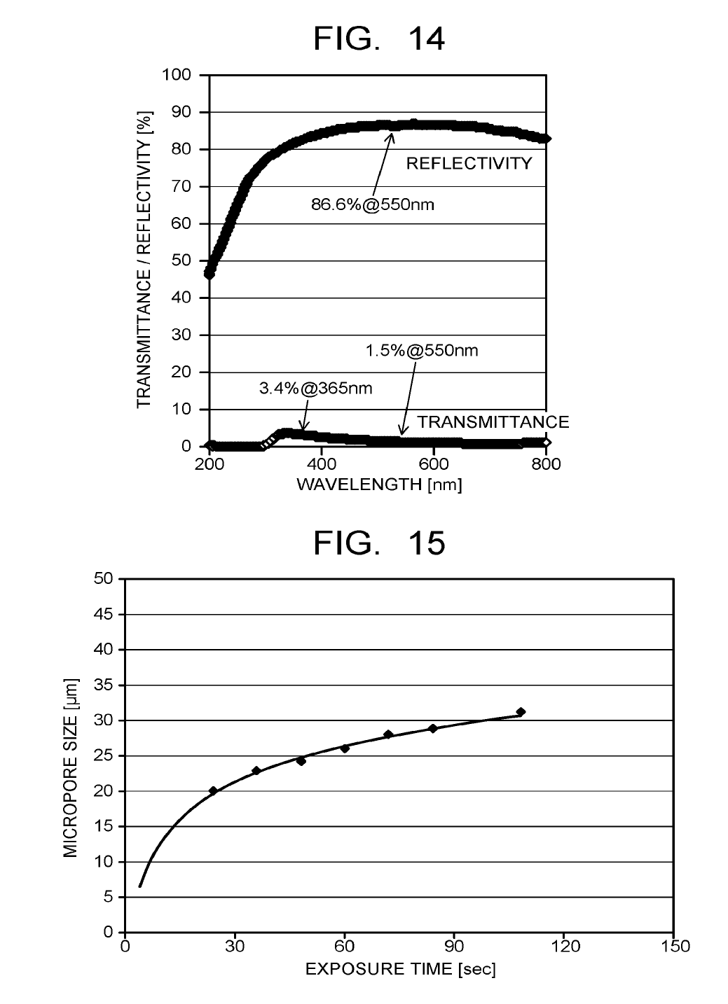

As a result of measurement of a focal length of the microlens array within the glass substrate, the focal length was at a position of 175 μm from a lens vertex. An aluminum film with a thickness of 28 nm was deposited by the vacuum deposition method at an opposite surface of the glass substrate from a surface where the microlens array was formed. Then transmission and reflection spectra of the deposited aluminum film were measured. These results are illustrated in FIG. 14. As for optical characteristics of the aluminum film, light transmittance at a wavelength of 365 nm was 3.4%, and light reflectivity at a wavelength of 550 nm was 86.6%.

The novolak resist was formed on the aluminum film by the spin coating method. Ultraviolet light was irradiated from the microlens array side by using an ultraviolet light source whose directivity half value width was one degree. A result of measurement of an amount of light at the wavelength of 365 nm by a power meter was 3.7 mW/cm². Development was performed with an alkaline developing solution for one minute after it was baked for 90 seconds on a hot-plate at a temperature of 110 degrees, and thereby, a micropore pattern was formed at the novolak resist. The glass substrate was immersed in the same alkaline developing solution as the developing solution of the resist for 15 seconds, and the aluminum film was wet-etched. The novolak resist was dissolved in an ethanol solution. Finally, the glass substrate was adhered on the aluminum film as the transparent flat plate 31.

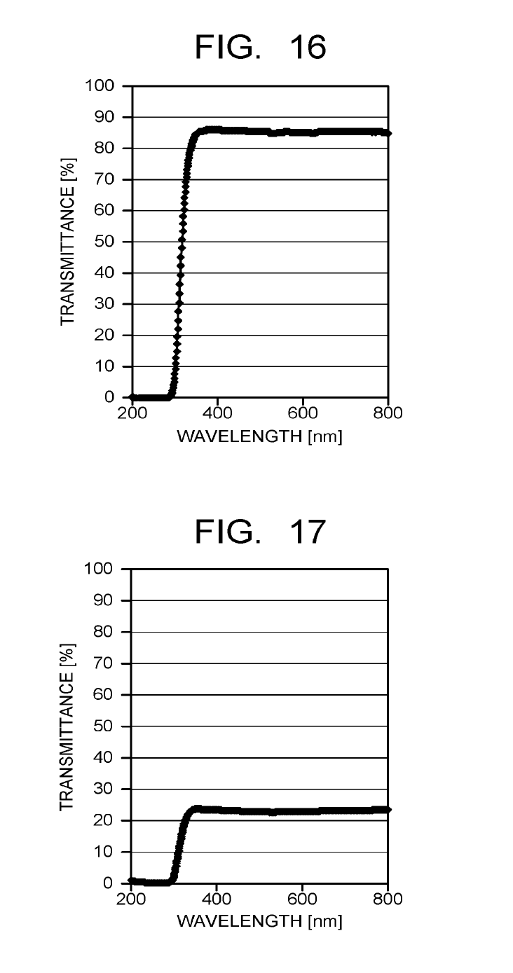

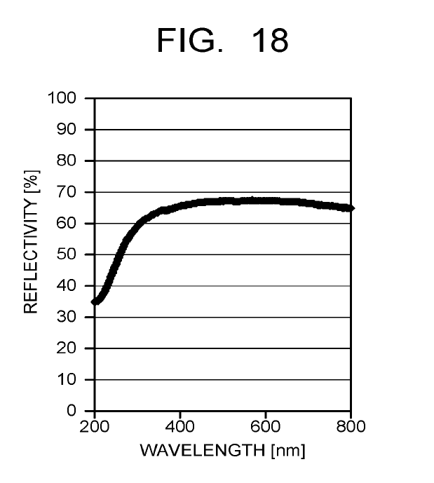

A relationship between the exposure time and the micropore diameter formed at the aluminum film is illustrated in FIG. 15. It was verified that the micropore diameter can be controlled by the exposure time. An average value of the micropore diameter which was formed while setting the exposure time to be 60 seconds was 25.5 μm. Measurement results of a transmission spectrum and a reflection spectrum of the composite body (special mirror) 105 of the microlens array part 20 and the mirror part 30 are illustrated in FIG. 16 to FIG. 18. FIG. 16 is the transmission spectrum measured from the microlens array part side, FIG. 17 is the transmission spectrum measured from the mirror part side, and FIG. 18 is the reflection spectrum measured from the mirror part side. In the transmittance and the reflectivity measured from the mirror part side, increase in the transmittance and decrease in the reflectivity which are equal to an area ratio of the micropores can be seen. The transmittance measured from the microlens array part side was approximately 90%, positions of the lens focal point and the micropore were matched, and it was verified to be the special mirror having high transmitting property and high reflecting property.

The special mirror was disposed on the liquid crystal display (directivity half value width: 5 degrees) to manufacture the mirror display. When a transmittance distribution and a reflectivity distribution at a display area of the liquid crystal display were measured in the mirror display as stated above, an average transmittance of the mirror display was 59%, an average reflectivity was 68%, and uniform optical characteristics were obtained in the display area. The special mirror manufactured by applying the above-stated manufacturing process is used for the display surface of the mirror display, and thereby, it is possible to enable both high reflecting property and high transmitting property. The special mirror according to the embodiment is able to be used for various optical devices such as a reflection layer of a semitransmissive liquid crystal display, a projecting plane of a projector, optical components using asymmetry of light in a solar cell, a photodetector, and so on without being limited to the mirror display.

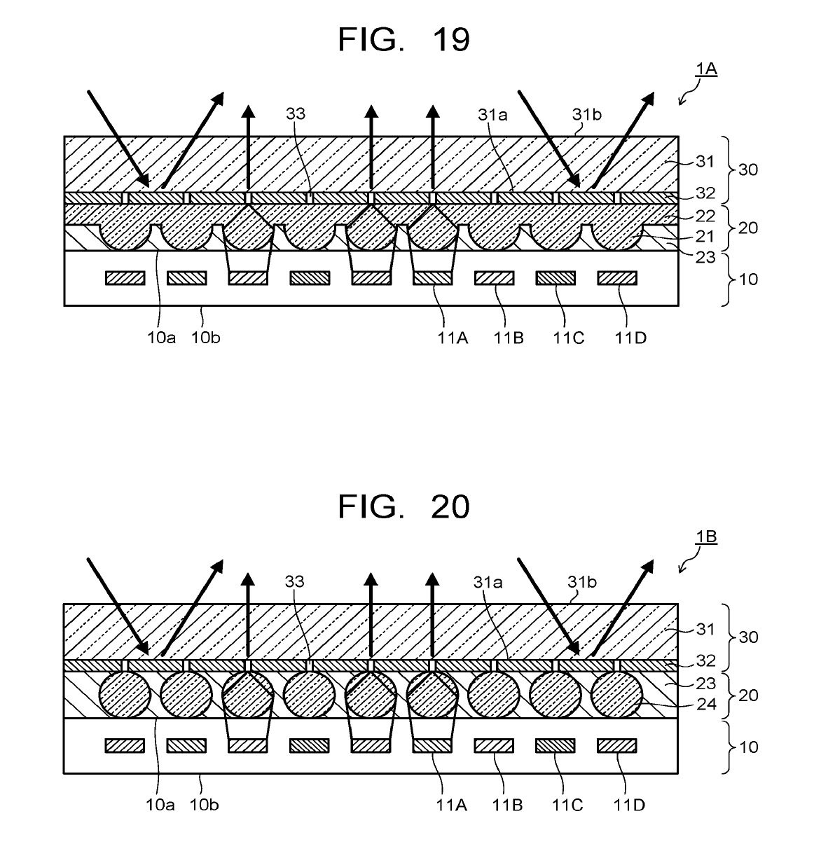

Modification examples of the display device according to the first embodiment are described with reference to FIG. 19 to FIG. 24. FIG. 19 illustrates a constitution of a first modification example of the display device 1 illustrated in FIG. 1. A display device 1A illustrated in FIG. 19 has a refractive index adjustment layer 23 provided at a space between the flat display part 10 and the microlens array part 20. The other constitutions are the same as FIG. 1. The refractive index adjustment layer 23 is formed by a lens material which makes up the microlens 21 and a transparent material whose refractive index is smaller than a surface material of the flat display part 10. The refractive index adjustment layer 23 is disposed, and thereby, it is possible to reduce optical loss resulting from an interface reflection, and to adjust a focal length of the microlens 21, simultaneously. The refractive index adjustment layer 23 also functions as a buffer material between the flat display part 10 and the microlens array part 20.

FIG. 20 illustrates a constitution of a second modification example of the display device 1 illustrated in FIG. 1. In a display device 1B illustrated in FIG. 20, the microlenses are made up of microball lenses 24. The microball lenses 24 are fixed between the flat display part 10 and the mirror part 30 by the refractive index adjustment layer 23. The micro-windows 33 formed at the reflective film 32 are formed in a post process in accordance with positions of the microball lenses 24. A shape of the micro-window 33 is near a circular shape. A size (diameter) of the micro-window 33 is preferably the resolution limit of the visual sense (approximately 1/16 mm) or less, and here, it is set to be 20 μm.

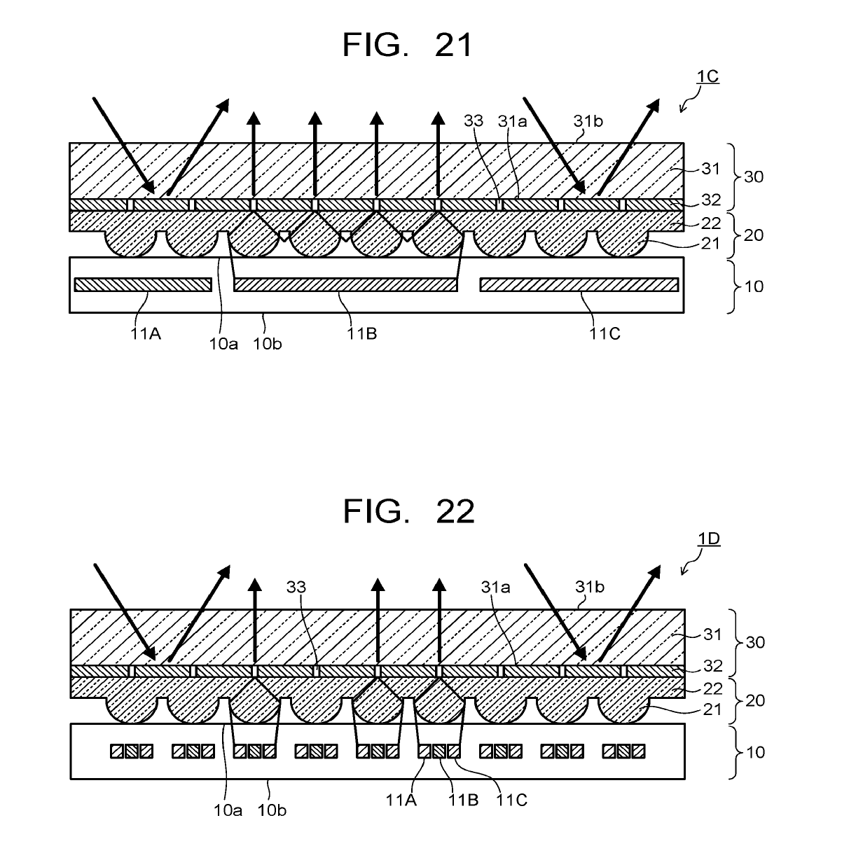

FIG. 21 illustrates a constitution of a third modification example of the display device 1 illustrated in FIG. 1. In a display device 1C illustrated in FIG. 21, the plurality of microlenses 21 correspond to one pixel 11 of the flat display part 10. A constitution in which individual microlens 21 each corresponds to one micro-window 33 is the same as the display device 1 illustrated in FIG. 1. The constitution as stated above is effective when the pixel 11 of the flat display part 10 is large and it is optically difficult to guide the light to the micro-window 33 by a single microlens 21, and when the microlens array part 20 is made to be thin as much as possible. In the display device 1C illustrated in FIG. 21, the shape of the micro-window 33 is set to be a square whose one side is 20 μm, and convex microlenses 21 are formed with a pitch of 50 μm. The pixels 11 are formed with a pitch of 200 μm.

FIG. 22 illustrates a constitution of a fourth modification example of the display device 1 illustrated in FIG. 1. In a display device 1D illustrated in FIG. 22, one microlens 21 corresponds to a group of a plurality of pixels 11A, 11B, 11C (pixel group) of the flat display part 10. The constitution in which individual microlens 21 each corresponds to one micro-window 33 is the same as FIG. 1. The constitution as stated above is effective when the pixel 11 of the flat display part 10 is extremely small, and when the microlens 21 with a diameter which is large as much as possible is to be used from a viewpoint of a manufacturing cost. In the display device 1D illustrated in FIG. 22, the shape of the micro-window 33 is set to be a square whose one side is 50 μm, and the convex microlenses 21 are formed with a pitch of 200 μm.

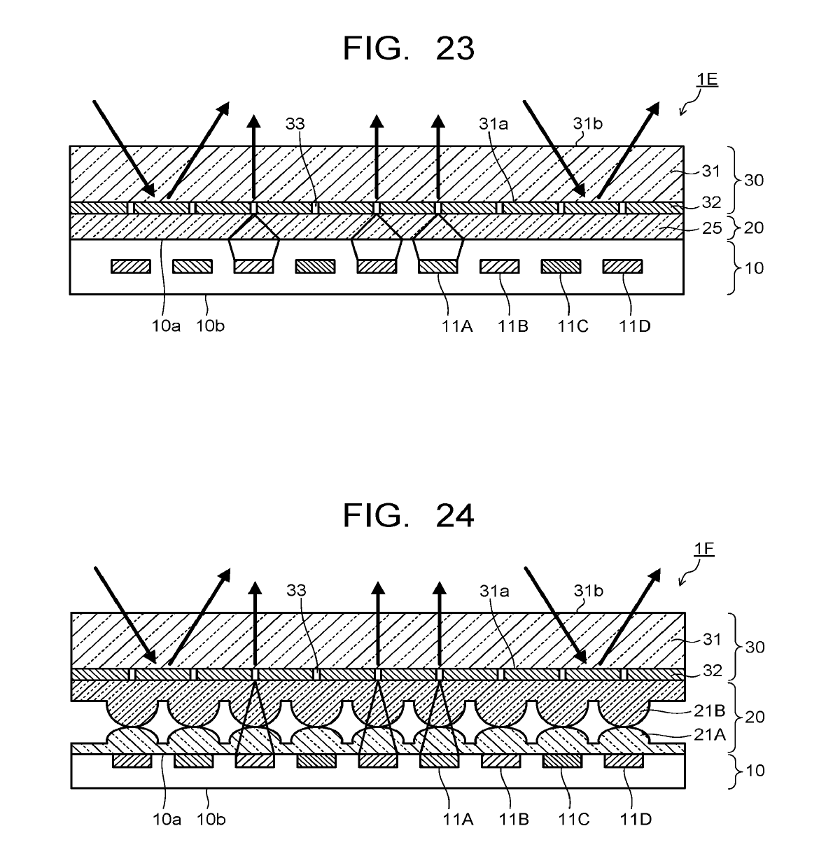

FIG. 23 illustrates a constitution of a fifth modification example of the display device 1 illustrated in FIG. 1. In a display device 1E illustrated in FIG. 23, the microlens is made up of a Fresnel lens 25. A constitution in which individual microlens in the Fresnel lens 25 each corresponds to one micro-window 33 is the same as FIG. 1. The constitution as stated above is effective when a thickness of the microlens array part (microlens sheet) 20 is to be controlled. Here, the Fresnel lens 25 is used, but it is possible to apply a diffraction lens instead thereof

FIG. 24 illustrates a constitution of a sixth modification example of the display device 1 illustrated in FIG. 1. In a display device 1F illustrated in FIG. 24, microlenses 21A, 21B are disposed at both sides of the pixel 11 side of the flat display part 10 and the reflective film 32 side of the mirror part 30. A constitution in which individual pair of microlenses (21A, 21B) each corresponds to one micro-window 33 is the same as FIG. 1. In the constitution as stated above, the pair of microlenses (21A, 21B) and the micro-window 33 may have correspondences as illustrated in FIG. 21 and FIG. 22 without being limited to a case having one to one correspondence. Further, the pair of microlenses (21A, 21B) may be formed by the Fresnel lens and the diffraction lens without being limited to the convex lens.

According to the display device 1 of the first embodiment, a mirror image equivalent to a mirror which is natural to the visual sense of human is given when the flat display part 10 is turned off. When the flat display part 10 is turned on, the light transmittance higher than a conventional constitution using the half mirror is held, and therefore, it is possible to show an image brighter. It is possible to provide the display device 1 with high performance as the mirror display compared to the conventional mirror display using the half mirror. Further, it is possible to easily form a mirror surface reflective film by processes such as coating of a window part by printing, and a partial plating in the manufacturing process of the special mirror, though the half mirror is sensitive for a film thickness of a reflective layer and high technology is required to enlarge the area thereof. In the manufacturing of the microlens, it is easy to form on the mirror surface because the size thereof is one capable of applying the printing process. It is thereby possible to reduce the manufacturing cost of the display device 1 functioning as the mirror display.

### Second Embodiment

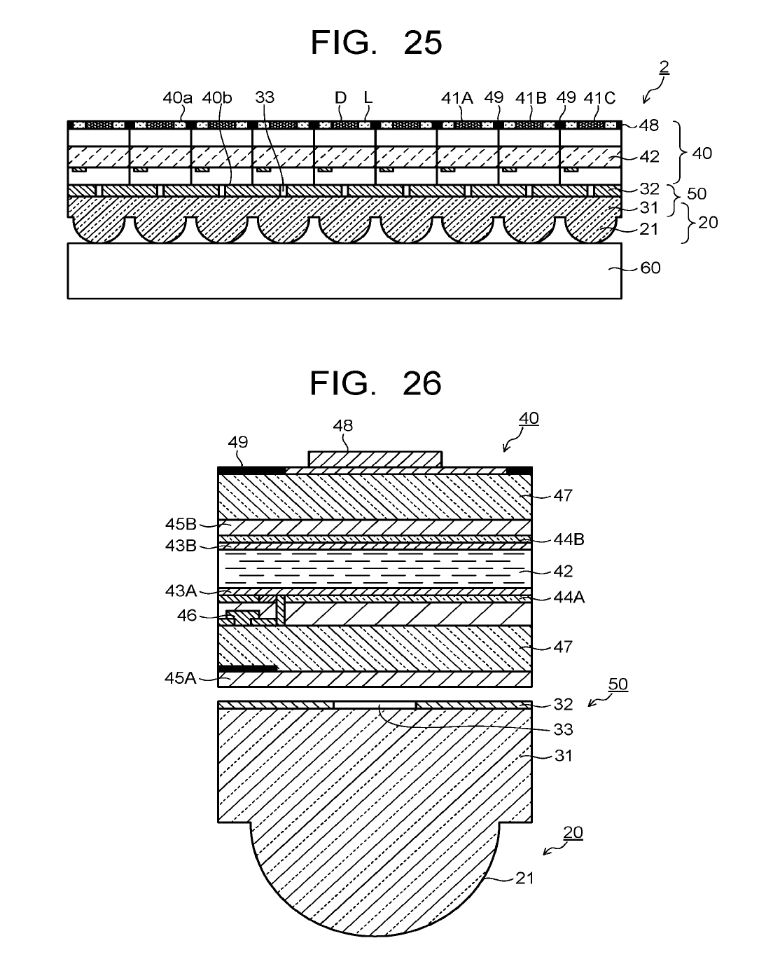

Next, a display device according to a second embodiment is described. FIG. 25 is a sectional view illustrating a constitution of the display device according to the second embodiment. A display device 2 illustrated in FIG. 25 includes a transmissive liquid crystal display 40, a reflection part 50, the microlens array part 20, and a backlight 60. The liquid crystal display 40 has a display surface 40a and a non-display surface 40b. The backlight 60 is disposed at the non-display surface 40b side of the liquid crystal display 40. Light emitted from the backlight 60 toward the liquid crystal display 40 is non-parallel light whose light emission angle distribution is skewed in the normal direction. The liquid crystal display 40 has pixels 41A, 41B, 41C, and a color image is displayed by light (reflected light of outside light or backlight) which transmits through these pixels 41A to 41C.

The liquid crystal display 40 has a liquid crystal layer 42 as illustrated in an enlarged view in FIG. 26. The liquid crystal layer 42 is sandwiched by transparent electrodes 44A, 44B disposed with alignment films 43A, 43B therebetween. The liquid crystal layer 42 is further sandwiched by deflecting plates 45A, 45B. The liquid crystal display 40 has a drive TFT 46 which turns on/off the liquid crystal layer 42 by each of the pixels 41A to 41C. A reference numeral 47 is a transparent base. A color filter 48 is disposed at the display surface 40a side of the liquid crystal display 40. A light shielding layer 49 is formed at each part corresponding between the pixels 41A to 41C of the color filter 48. The liquid crystal display 40 performs the reflection display by using the light in which the outside light is reflected when the outside light such as sunlight or illumination light is obtained, and performs the transmission display by using the light in which the backlight is transmitted when the outside light is dark. The liquid crystal display 40 is the hybrid-type liquid crystal display.

The reflection part 50 and the microlens array part 20 are disposed between the liquid crystal display 40 and the backlight 60. The reflection part 50 has a constitution similar to the mirror part 30 in the first embodiment. The reflection part 50 has the transparent flat plate 31, the reflective film 32 provided at one surface of the transparent flat plate 31, and the plurality of micro-windows 33 formed at the reflective film 32. Basically, these have the constitution similar to each element of the mirror part 30 in the first embodiment, and the shapes thereof, the formation materials, the formation methods, and so on are also similar thereto. Note that in the display device 2 of the second embodiment, the reflection part 50 is one performing the reflection display of the liquid crystal display 40 by using the light in which the outside light is reflected, and does not have a function as a mirror. It is not necessary to set the size of the micro-window 33 to be the resolution limit or less of the human visual sense. The reflection part 50 is disposed such that the reflective film 32 is located at the non-display surface 40b side of the liquid crystal display 40.

The microlens array part 20 which has the plurality of microlenses 21 converging the non-parallel light emitted from the backlight 60 toward the liquid crystal display 40 via the reflection part 50 to each of the plurality of micro-windows 33 is disposed between the reflection part 50 and the backlight 60. The plurality of microlenses 21 correspond to the micro-windows 33 individually. Optical characteristics of the individual microlens 21 are adjusted such that the light which is incident on a lens opening part from the backlight 60 is converged into the micro-window 33 and transmits. The pixels 41A to 41C in respective colors of the liquid crystal display 40 correspond to the individual microlenses 21. A correspondence between the pixel 41 of the liquid crystal display 40 and the microlens 21 is not limited to one-to-one correspondence but the plurality of micro-windows 33 may be corresponded to one pixel 41 or one microlens 21 may be corresponded to the plurality of pixels 41A to 41C as same as the first embodiment.

In the display device 2 illustrated in FIG. 25, the microlenses 21 are formed on a substrate which is common to the transparent flat plate 31 of the reflection part 50. The microlens array part 20 may be formed on a transparent supporter which is a separated body from the transparent flat plate 31 of the reflection part 50. In such a case, a microlens array sheet where the microlenses 21 are formed and the reflection part 50 are adhered while aligning positions, and thereby, it is possible to form a laminated body of the reflection part 50 and the microlens array part 20. It is possible to use the refractive lens and the diffraction lens as same as the first embodiment for the microlens 21. The formation method of the microlens array part 20 is also similar to the first embodiment. It is preferable to form the microlenses 21 and the micro-windows 33 by applying the manufacturing process illustrated in FIG. 9A to FIG. 9I.

The display device 2 of the second embodiment reflects the outside light by the reflective film 32 when the outside light such as sunlight or illumination light can be obtained, and the liquid crystal display 40 is displayed by using this reflection light. At this time, the reflective film 32 where the micro-windows 33 are formed functions as a reflection body having the reflectivity defined by the open area ratio, and therefore, it is possible to increase the reflectivity of the outside light compared to a conventional partial mirror. When the outside light is dark, the backlight 60 is lighted, and the liquid crystal display 40 is displayed by the light emitted from the backlight 60. At this time, the backlight is converged to the micro-windows 33 by the microlenses 21, and transmits through the micro-windows 33. The liquid crystal display 40 is displayed by the light which transmits through the micro-windows 33.

As stated above, the optical component in which the micro-windows and the microlenses which adjust the focus thereto are combined is optically asymmetry, and the transmittance and the reflectivity relative to the parallel light are largely different depending on an incident direction. The optical component in which the micro-windows and the microlenses are combined is effective as a component which changes the light passing through the micro-windows into the light near the parallel light, or as a component which focuses the parallel light into one point. Note that the backlight 60 is generally a spread light source, and it is difficult to converge the non-parallel light emitted from the spread light source to the micro-windows 33 by the microlenses 21. A range of the emission angle distribution of the light emitted from the backlight 60 is therefore limited. Specifically, the light emission angle distribution (envelope) is skewed in the normal direction. The non-parallel light whose light emission angle distribution is skewed in the normal direction is easy to be converged to the micro-windows 33 by the microlenses 21. Therefore, it is possible to increase an amount of the backlight which reaches the liquid crystal display 40.

As a concrete example of the backlight 60, the backlight 12 illustrated in FIG. 2 can be cited. As illustrated in FIG. 3, the maximum intensity of the light emitted from the backlight 12 exists in the normal direction, and the range from ½ (half value) of the maximum intensity to the maximum intensity is approximately ±20 degrees relative to the normal direction. It is preferable that the half value width of the light emission angle distribution relative to the air is within ±25 degrees as a practical standard. The light (non-parallel light) emitted from the backlight 12 is preferable to have the light emission angle distribution in which an angle which forms the maximum intensity is the normal direction and the angle (half value angle θ) to be ½ of the maximum intensity is within ±25 degrees relative to the normal direction. The non-parallel light having the light emission angle distribution as stated above is applied, and thereby, a major part thereof passes through the micro-windows 33. Accordingly, it is possible to increase the amount of light transmitting through the reflection part 50. The angle θ to be ½ of the maximum intensity is more preferable to be within ±20 degrees relative to the normal direction.

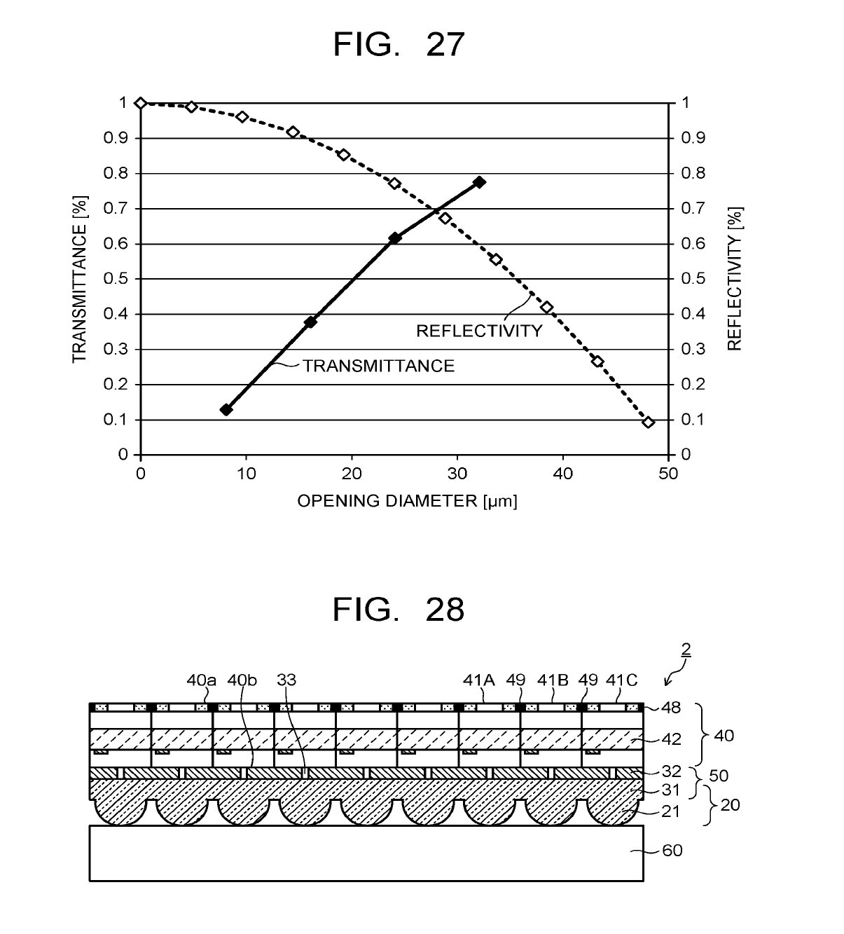

Results of calculations of light reflectivity and light transmittance are illustrated in FIG. 27 when the backlight 12 (60) where two pieces of prism sheets (for example, BEF sheets manufactured by Sumitomo 3M corporation) are orthogonally disposed and a hemispherical lens array (diameter of 48 μm, sheet thickness of 48 μm, refractive index of 1.47) 20 where a closest disposition is performed with a pitch of 48 μm are used, and the opening diameter of the micro-window 33 is changed. For example, when the opening diameter (diameter) of the micro-window 33 is 27 μm, the light reflectivity and the light transmittance are each approximately 70% (a sum of the light reflectivity and the light transmittance is approximately 140%). According to the display device 2 of the second embodiment, it is possible to drastically relax the trade-off relationship between the light reflectivity and the light transmittance compared to the hybrid-type liquid crystal display using the conventional partial mirror in which the sum of the light reflectivity and the light transmittance becomes 100%. Namely, it becomes possible to improve both reflection display characteristics and transmission display characteristics.

An opening diameter W of the micro-window 33 formed at the reflective film 32 preferably has a size of the spreading of light or more as same as the first embodiment. When the microlens 21 made up of a material which is transparent for the visible light (refractive index n) and the supporter 22 made up of the transparent material (refractive index n) which is the same as the formation material of the microlens 21 are used, the opening diameter W of the micro-window 33 is preferable to satisfy the following relationship relative to a lens thickness d, the refractive index n of the transparent material, and the half value angle θ,

d·tan [arcsin(sin θ/n)]≦W/2.

When the microlens 21 made up of a first material (refractive index n1) which is transparent for the visible light with a thickness of d1 and the supporter 22 made up of a second material (refractive index n2) which is transparent for the visible light being different from the first material with a thickness of d2 are used, the opening diameter W of the micro-window 33 is preferable to satisfy following relationship relative to the thickness d1 of the microlens 21, the thickness d2 of the supporter 22, the refractive index n1 of the first transparent material, the refractive index n2 of the second transparent material, and the half value angle θ,

d1·tan [arcsin(sin θ/n1)]+d2·tan [arcsin(sin θ/n2)]≦W/2.

Concrete examples of a constitution of the microlens 21 and optical paths are as illustrated in FIG. 5 to FIG. 7, and the same structure is applied also in the second embodiment.

In the display device 2 illustrated in FIG. 25, a color density of each of regions of the color filter 48 which correspond to the micro-windows 33 is made thick (dark part D), and a color density of a peripheral part is made light (light part L). It is difficult to display a bright color by the transmission display in the conventional hybrid-type liquid crystal display. As illustrated in FIG. 25, the color filter 48 having the dark parts D and the light parts L, the micro-windows 33, and the microlenses 21 are combined, and thereby, the hybrid-type liquid crystal display capable of exhibiting the bright color is provided. As illustrated in FIG. 28, the regions which correspond to the micro-windows 33 of the color filter 48 are made colorless, and thereby, the hybrid-type liquid crystal display capable of displaying a bright white image is provided.

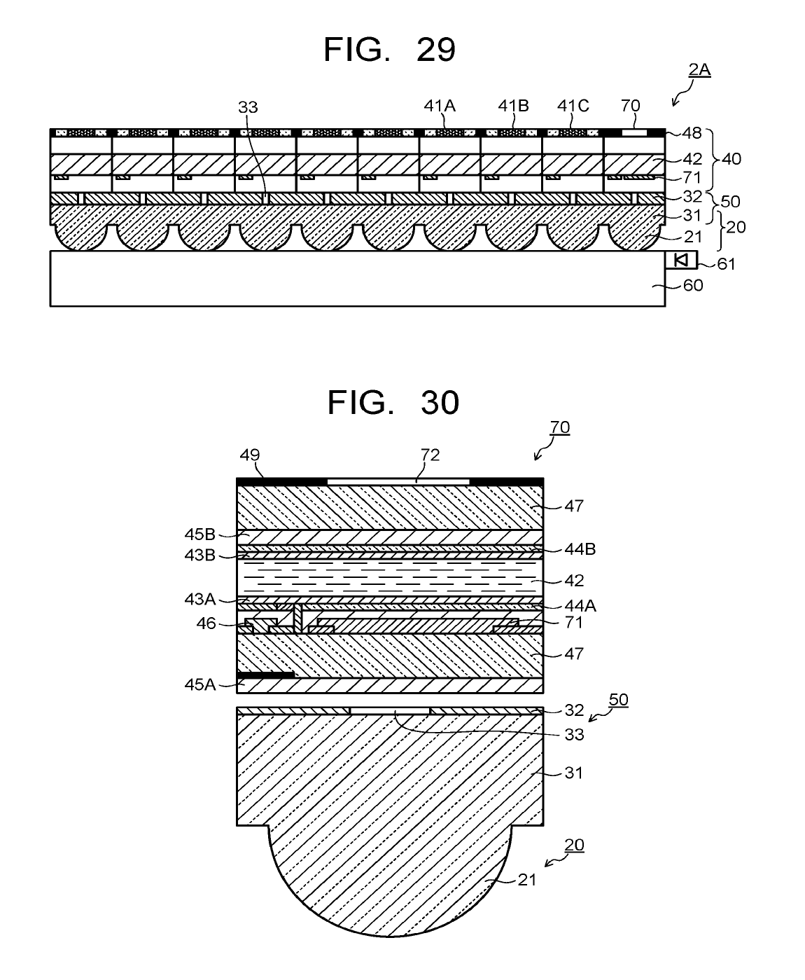

Next, a modification example of the display device according to the second embodiment is described with reference to FIG. 29 and FIG. 30. In a display device 2A illustrated in FIG. 29 and FIG. 30, a photosensor part 70 is added to a part of a pixel region of the liquid crystal display 40. The photosensor part 70 has a photosensor 71 as illustrated in an enlarged view in FIG. 30. A light control window 72 whose shape and opening area are adjusted is provided at an upper part of the photosensor 71 so that an intensity balance between the outside light and the backlight is taken. The photosensor part 70 also has the micro-windows 33 provided at the reflective film 32 and the microlenses 21 at a lower part thereof as same as the other pixel regions.

The backlight 60 has an LED 61 which adjusts light intensity in a plane. The intensity of the outside light is measured by the photosensor 71, and the light intensity in the plane of the backlight 60 is adjusted by the LED 61 according thereto. The light intensity in the plane of the backlight 60 is adjusted such that the intensity balance is taken with the intensity of the outside light measured by the photosensor 71. Namely, the light intensity in the plane of the backlight 60 is adjusted such that the intensity in which the outside light and the backlight are added becomes uniform in the plane of the liquid crystal display 40. According to the display device 2A as stated above, it is possible to simultaneously enable a high quality display and energy saving.

Incidentally, constitutions of the first and second embodiments are able to be applied while combining with each other, further it is possible to replace a part thereof. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device, comprising:
a mirror part including a flat plate transparent for visible light, a reflective film formed at one surface of the transparent flat plate, and a plurality of micro-windows formed on the reflective film;
a flat display part, disposed at a formation surface side of the reflective film of the mirror part, emitting non-parallel light whose light emission angle distribution is skewed in a normal direction toward the mirror part; and
a microlens array part, disposed between the mirror part and the flat display part, including a plurality of microlenses converging the non-parallel light emitted from the flat display part toward the mirror part to the plurality of micro-windows individually.

2. The display device of claim 1,
wherein an opening diameter W of the micro-window is 1/16 mm or less.

3. The display device of claim 1,
wherein the non-parallel light has the light emission angle distribution in which an angle forming a maximum intensity is the normal direction relative to the reflective film and an angle θ to be ½ of the maximum intensity is within ±25 degrees relative to the normal direction.

4. The display device of claim 3,
wherein the microlens array part includes the plurality of microlenses which are each made up of a material transparent for visible light and a supporter which is made up of the same material as the transparent material and supports the plurality of microlenses,
an opening diameter W of the micro-window satisfies the following formula:
d·tan [arcsin(sin θ/n)]≦W/2,
wherein d is a total thickness of the microlens and the supporter, n is a refractive index of the transparent material, and θ is the angle to be ½ of the maximum intensity of the non-parallel light.

5. The display device of claim 3,
wherein the microlens array part includes the plurality of microlenses which are each made up of a first material transparent for visible light and a supporter which is made up of a second material transparent for visible light being different from the first material and supports the plurality of microlenses,
an opening diameter W of the micro-window satisfies the following formula:
d1·tan [arcsin(sin θ/n1)]+d2·tan [arcsin(sin θ/n2)]≦W/2,
wherein d1 is a thickness of the microlens, d2 is a thickness of the supporter, n1 is a refractive index of the first material, n2 is a refractive index of the second material, and θ is the angle to be ½ of the maximum intensity of the non-parallel light.

6. The display device of claim 1,
wherein the plurality of micro-windows correspond to each of pixels of the flat display part.

7. A display device, comprising:
a light-transmissive liquid crystal display having a display surface and a non-display surface;
a reflection part which includes a flat plate transparent for visible light, a reflective film formed at one surface of the transparent flat plate, and a plurality of micro-windows formed on the reflective film, and is disposed along the non-display surface of the liquid crystal display to locate the reflective film at the liquid crystal display side;
a backlight emitting non-parallel light whose light emission angle distribution is skewed in a normal direction toward the liquid crystal display via the reflection part; and
a microlens array part, disposed between the reflection part and the backlight, including a plurality of microlenses converging the non-parallel light emitted from the backlight toward the reflection part to the plurality of micro-windows individually.

8. The display device of claim 7,
wherein the non-parallel light has the light emission angle distribution in which an angle which forms a maximum intensity is the normal direction relative to the reflective film and an angle θ to be ½ of the maximum intensity is within ±25 degrees relative to the normal direction.

9. The display device of claim 8,
wherein the microlens array part includes the plurality of microlenses which are each made up of a material transparent for visible light and a supporter which is made up of the same material as the transparent material and supports the plurality of microlenses,
an opening diameter W of the micro-window satisfies the following formula:
d·tan [arcsin(sin θ/n)]≦W/2,
wherein d is a total thickness of the microlens and the supporter, n is a refractive index of the transparent material, and θ is the angle to be ½ of the maximum intensity of the non-parallel light.

10. The display device of claim 8,
wherein the microlens array part includes the plurality of microlenses which are each made up of a first material transparent for visible light and a supporter which is made up of a second material transparent for visible light being different from the first material, and supports the plurality of microlenses,
an opening diameter W of the micro-window satisfies the following formula:
d1·tan [arcsin(sin θ/n1)]+d2·tan [arcsin(sin θ/n2)]≦W/2,
wherein d1 is a thickness of the microlens, d2 is a thickness of the supporter, n1 is a refractive index of the first material, n2 is a refractive index of the second material, and θ is the angle to be ½ of the maximum intensity of the non-parallel light.

11. A manufacturing method of a display device, comprising:
preparing a mirror part which includes a flat plate transparent for visible light, a reflective film formed at one surface of the transparent flat plate, and a plurality of micro-windows formed on the reflective film;
disposing a microlens array part which includes a plurality of microlenses converging non-parallel light whose light emission angle distribution is skewed in a normal direction to the plurality of micro-windows individually at a formation surface side of the reflective film of the mirror part; and
disposing a flat display part which emits the non-parallel light toward the mirror part via the microlens array part along the microlens array part.

12. The manufacturing method according to claim 11,
wherein the preparing the mirror part includes:
forming the plurality of microlenses on a first surface of a supporter;
forming the reflective film on a second surface of the supporter;
forming a photosensitive layer on the reflective film;
forming a pattern which corresponds to the plurality of micro-windows at the photosensitive layer by irradiating light to the photosensitive layer via the plurality of microlenses from the second surface side of the supporter; and
forming the plurality of micro-windows at the reflective film by transferring the pattern on the reflective film,
wherein the reflective film has a transmitting property relative to a photosensitive wavelength region of the photosensitive layer.

13. The manufacturing method of claim 12,
wherein the photosensitive wavelength region of the photosensitive layer is 450 nm or less, and
light reflectivity of the reflective film relative to a wavelength of 550 nm is 70% or more, and the reflective film has a wavelength region whose light transmittance is 0.1% or more at a range of a wavelength of 450 nm or less.

14. The manufacturing method of claim 13,
wherein light transmittance of the supporter and the microlens relative to the wavelength of 550 nm is 70% or more, and the supporter and the microlens each have a wavelength region whose light transmittance is 10% or more at the range of the wavelength of 450 nm or less.

15. The manufacturing method of claim 13,
wherein the reflective film includes a metal film containing at least one selected from the group consisting of aluminum and silver, or a dielectric multilayer film.
